(19) United States
(12) Patent Application Publication
(10) Pub. No.: US 2016/0156880 A1
(43) Pub. Date: Jun. 2, 2016

(54) DURABLE COMPACT MULTISENSOR OBSERVATION DEVICES

(71) Applicant: FLIR Systems, Inc., Wilsonville, OR (US)

(72) Inventors: Andrew C. Teich, West Linn, OR (US); Jeffrey D. Frank, Santa Barbara, CA (US); Brent Lammert, Wilmington, NC (US); Thomas J. Scanlon, Hampstead, NH (US); Nicholas Högasten, Santa Barbara, CA (US); Theodore R. Hoelter, Goleta, CA (US); Katrin Strandemar, Rimbo (SE); Pierre Boulanger, Goleta, CA (US); Eric A. Kurth, Santa Barbara, CA (US); Barbara Sharp, Santa Barbara, CA (US)

(21) Appl. No.: 14/506,377

(22) Filed: Oct. 3, 2014

Related U.S. Application Data
(63) Continuation-in-part of application No. 13/940,232, filed on Jul. 11, 2013.
Application No. 13/940,232 is a continuation-in-part of application No. 14/137,573, filed on Dec. 20, 2013.
Application No. 14/137,573 is a continuation-in-part of application No. 13/043,123, filed on Mar. 8, 2011, now Pat. No. 8,766,808.
Application No. 13/043,123 is a continuation-in-part of application No. 14/101,245, filed on Dec. 9, 2013.
Application No. 14/101,245 is a continuation of application No. PCT/US2012/041744, filed on Jun. 8, 2012.
Application No. PCT/US2012/041744 is a continuation-in-part of application No. 14/099,818, filed on Dec. 6, 2013.
Application No. 14/099,818 is a continuation of application No. PCT/US2012/041749, filed on Jun. 8, 2012.
Application No. PCT/US2012/041749 is a continuation-in-part of application No. 14/101,258, filed on Dec. 9, 2013.
Application No. 14/101,258 is a continuation of application No. PCT/US2012/041739, filed on Jun. 8, 2012.
Application No. PCT/US2012/041739 is a continuation-in-part of application No. 13/437,645, filed on Apr. 2, 2012, now Pat. No. 9,171,361.
Application No. 13/437,645 is a continuation-in-part of application No. 13/105,765, filed on May 11, 2011, now Pat. No. 8,565,547.
Application No. 13/105,765 is a continuation-in-part of application No. 12/766,739, filed on Apr. 23, 2010, now Pat. No. 8,520,970.
Application No. 12/766,739 is a continuation of application No. PCT/EP2011/056432, filed on Apr. 21, 2011.
Application No. PCT/EP2011/056432 is a continuation-in-part of application No. 12/766,739, filed on Apr. 23, 2010, now Pat. No. 8,520,970.
Application No. PCT/EP2011/056432 is a continuation-in-part of application No. 12/766,739, filed on Apr. 23, 2010, now Pat. No. 8,520,970.
Application No. 12/766,739 is a continuation-in-part of application No. 14/138,058, filed on Dec. 21, 2013.
Application No. 14/138,058 is a continuation-in-part of application No. 14/299,987, filed on Jun. 9, 2014, now Pat. No. 9,083,897.
Application No. 14/299,987 is a continuation of application No. 12/477,828, filed on Jun. 3, 2009, now Pat. No. 8,749,635.
Application No. 12/477,828 is a continuation-in-part of application No. 14/138,040, filed on Dec. 21, 2013.
Application No. 14/138,040 is a continuation-in-part of application No. 14/138,052, filed on Dec. 21, 2013.
(60) Provisional application No. 61/886,516, filed on Oct. 3, 2013.
(60) Provisional application No. 61/670,824, filed on Jul. 12, 2012.
(60) Provisional application No. 61/745,193, filed on Dec. 21, 2012.
(60) Provisional application No. 61/312,146, filed on Mar. 9, 2010.
(60) Provisional application No. 61/656,889, filed on Jun. 7, 2012.
(60) Provisional application No. 61/545,056, filed on Oct. 7, 2011.
(60) Provisional application No. 61/495,873, filed on Jun. 10, 2011.
(60) Provisional application No. 61/495,879, filed on Jun. 10, 2011.
(60) Provisional application No. 61/495,888, filed on Jun. 10, 2011.
(60) Provisional application No. 61/545,056, filed on Oct. 7, 2011.
(60) Provisional application No. 61/495,873, filed on Jun. 10, 2011.
(60) Provisional application No. 61/495,879, filed on Jun. 10, 2011.
(60) Provisional application No. 61/495,888, filed on Jun. 10, 2011.
(60) Provisional application No. 61/495,873, filed on Jun. 10, 2011.
(60) Provisional application No. 61/495,879, filed on Jun. 10, 2011.
(60) Provisional application No. 61/495,888, filed on Jun. 10, 2011.
(60) Provisional application No. 61/473,207, filed on Apr. 8, 2011.
(60) Provisional application No. 61/473,207, filed on Apr. 8, 2011.
(60) Provisional application No. 61/748,018, filed on Dec. 31, 2012.
(60) Provisional application No. 61/792,582, filed on Mar. 15, 2013.
(60) Provisional application No. 61/746,069, filed on Dec. 26, 2012.
(60) Provisional application No. 61/793,952, filed on Mar. 15, 2013.
(60) Provisional application No. 61/746,074, filed on Dec. 26, 2012.

(51) Int. Cl. H04N 7/18; G06K 9/00; H04N 5/33; H04N 5/225; H04N 5/265

(52) U.S. Cl. CPC H04N 7/185; H04N 5/2252; H04N 5/265; H04N 5/33; G06K 9/00771

(57) ABSTRACT

Systems having throwable devices with thermal imaging capabilities may be provided for observing a potentially hazardous environment with possible human or environmental threats. A system may include a throwable observation device configured to be thrown into the potentially hostile environment and to capture at least thermal images of portions of the environment and a mobile handset configured to wirelessly receive the captured thermal images from the observation device. The observation device may include a durable housing structure having openings, an imaging module in each of the openings, a processor for processing the captured thermal images, and communications components for transmitting the captured thermal images to the mobile handset. The mobile handset may include a processor for further processing the received captured thermal images and a display for displaying processed thermal images.

### CROSS-REFERENCE TO RELATED APPLICATIONS

This application claims the benefit of U.S. Provisional Patent Application No. 61/886,516 filed Oct. 3, 2013 and entitled “DURABLE COMPACT MULTISENSOR OBSERVATION DEVICES” which is hereby incorporated by reference in its entirety.

This application is a continuation-in-part of U.S. patent application Ser. No. 13/940,232 filed Jul. 11, 2013 and entitled “INFANT MONITORING SYSTEMS AND METHODS USING THERMAL IMAGING” which is hereby incorporated by reference in its entirety.

U.S. patent application Ser. No. 13/940,232 claims the benefit of U.S. Provisional Patent Application No. 61/670,824 filed Jul. 12, 2012 and entitled “INFANT MONITORING SYSTEMS AND METHODS USING THERMAL IMAGING” which is hereby incorporated by reference in its entirety.

This application is a continuation-in-part of U.S. patent application Ser. No. 14/137,573 filed Dec. 20, 2013 and entitled “IMAGER WITH ARRAY OF MULTIPLE INFRARED IMAGING MODULES” which is hereby incorporated by reference in its entirety.

U.S. patent application Ser. No. 14/137,573 claims the benefit of U.S. Provisional Patent Application No. 61/745,193 filed Dec. 21, 2012 and entitled “IMAGER WITH ARRAY OF MULTIPLE INFRARED IMAGING MODULES” which is hereby incorporated by reference in its entirety.

U.S. patent application Ser. No. 14/137,573 is a continuation-in-part of U.S. patent application Ser. No. 13/043,123 filed Mar. 8, 2011 and entitled “IMAGER WITH MULTIPLE SENSOR ARRAYS” which is hereby incorporated by reference in its entirety.

U.S. patent application Ser. No. 13/043,123 claims the benefit of U.S. Provisional Patent Application No. 61/312,146 filed Mar. 9, 2010 and entitled “MULTI SPECTRAL MINIATURE SENSOR” which is hereby incorporated by reference in its entirety.

This application is a continuation-in-part of U.S. patent application Ser. No. 14/101,245 filed Dec. 9, 2013 and entitled “LOW POWER AND SMALL FORM FACTOR INFRARED IMAGING” which is hereby incorporated by reference in its entirety.

U.S. patent application Ser. No. 14/101,245 is a continuation of International Patent Application No. PCT/US2012/041744 filed Jun. 8, 2012 and entitled “LOW POWER AND SMALL FORM FACTOR INFRARED IMAGING” which is hereby incorporated by reference in its entirety.

International Patent Application No. PCT/US2012/041744 claims the benefit of U.S. Provisional Patent Application No. 61/656,889 filed Jun. 7, 2012 and entitled “LOW POWER AND SMALL FORM FACTOR INFRARED IMAGING” which is hereby incorporated by reference in its entirety.

International Patent Application No. PCT/US2012/041744 claims the benefit of U.S. Provisional Patent Application No. 61/545,056 filed Oct. 7, 2011 and entitled “NON-UNIFORMITY CORRECTION TECHNIQUES FOR INFRARED IMAGING DEVICES” which is hereby incorporated by reference in its entirety.

International Patent Application No. PCT/US2012/041744 claims the benefit of U.S. Provisional Patent Application No. 61/495,873 filed Jun. 10, 2011 and entitled “INFRARED CAMERA PACKAGING SYSTEMS AND METHODS” which is hereby incorporated by reference in its entirety.

International Patent Application No. PCT/US2012/041744 claims the benefit of U.S. Provisional Patent Application No. 61/495,879 filed Jun. 10, 2011 and entitled “INFRARED CAMERA SYSTEM ARCHITECTURES” which is hereby incorporated by reference in its entirety.

International Patent Application No. PCT/US2012/041744 claims the benefit of U.S. Provisional Patent Application No. 61/495,888 filed Jun. 10, 2011 and entitled “INFRARED CAMERA CALIBRATION TECHNIQUES” which is hereby incorporated by reference in its entirety.

This application is a continuation-in-part of U.S. patent application Ser. No. 14/099,818 filed Dec. 6, 2013 and entitled “NON-UNIFORMITY CORRECTION TECHNIQUES FOR INFRARED IMAGING DEVICES” which is hereby incorporated by reference in its entirety.

U.S. patent application Ser. No. 14/099,818 is a continuation of International Patent Application No. PCT/US2012/041749 filed Jun. 8, 2012 and entitled “NON-UNIFORMITY CORRECTION TECHNIQUES FOR INFRARED IMAGING DEVICES” which is hereby incorporated by reference in its entirety.

International Patent Application No. PCT/US2012/041749 claims the benefit of U.S. Provisional Patent Application No. 61/545,056 filed Oct. 7, 2011 and entitled “NON-UNIFORMITY CORRECTION TECHNIQUES FOR INFRARED IMAGING DEVICES” which is hereby incorporated by reference in its entirety.

International Patent Application No. PCT/US2012/041749 claims the benefit of U.S. Provisional Patent Application No. 61/495,873 filed Jun. 10, 2011 and entitled “INFRARED CAMERA PACKAGING SYSTEMS AND METHODS” which is hereby incorporated by reference in its entirety.

International Patent Application No. PCT/US2012/041749 claims the benefit of U.S. Provisional Patent Application No. 61/495,879 filed Jun. 10, 2011 and entitled “INFRARED CAMERA SYSTEM ARCHITECTURES” which is hereby incorporated by reference in its entirety.

International Patent Application No. PCT/US2012/041749 claims the benefit of U.S. Provisional Patent Application No. 61/495,888 filed Jun. 10, 2011 and entitled “INFRARED CAMERA CALIBRATION TECHNIQUES” which is hereby incorporated by reference in its entirety.

This application is a continuation-in-part of U.S. patent application Ser. No. 14/101,258 filed Dec. 9, 2013 and entitled “INFRARED CAMERA SYSTEM ARCHITECTURES” which is hereby incorporated by reference in its entirety.

U.S. patent application Ser. No. 14/101,258 is a continuation of International Patent Application No. PCT/US2012/041739 filed Jun. 8, 2012 and entitled “INFRARED CAMERA SYSTEM ARCHITECTURES” which is hereby incorporated by reference in its entirety.

International Patent Application No. PCT/US2012/041739 claims the benefit of U.S. Provisional Patent Application No. 61/495,873 filed Jun. 10, 2011 and entitled “INFRARED CAMERA PACKAGING SYSTEMS AND METHODS” which is hereby incorporated by reference in its entirety.

International Patent Application No. PCT/US2012/041739 claims the benefit of U.S. Provisional Patent Application No. 61/495,879 filed Jun. 10, 2011 and entitled “INFRARED CAMERA SYSTEM ARCHITECTURES” which is hereby incorporated by reference in its entirety.

International Patent Application No. PCT/US2012/041739 claims the benefit of U.S. Provisional Patent Application No. 61/495,888 filed Jun. 10, 2011 and entitled “INFRARED CAMERA CALIBRATION TECHNIQUES” which is hereby incorporated by reference in its entirety.

This application is a continuation-in-part of U.S. patent application Ser. No. 13/437,645 filed Apr. 2, 2012 and entitled “INFRARED RESOLUTION AND CONTRAST ENHANCEMENT WITH FUSION” which is hereby incorporated by reference in its entirety.

U.S. patent application Ser. No. 13/437,645 is a continuation-in-part of U.S. patent application Ser. No. 13/105,765 filed May 11, 2011 and entitled “INFRARED RESOLUTION AND CONTRAST ENHANCEMENT WITH FUSION” which is hereby incorporated by reference in its entirety.

U.S. patent application Ser. No. 13/437,645 also claims the benefit of U.S. Provisional Patent Application No. 61/473,207 filed Apr. 8, 2011 and entitled “INFRARED RESOLUTION AND CONTRAST ENHANCEMENT WITH FUSION” which is hereby incorporated by reference in its entirety.

U.S. patent application Ser. No. 13/437,645 is also a continuation-in-part of U.S. patent application Ser. No. 12/766,739 filed Apr. 23, 2010 and entitled “INFRARED RESOLUTION AND CONTRAST ENHANCEMENT WITH FUSION” which is hereby incorporated by reference in its entirety.

U.S. patent application Ser. No. 13/105,765 is a continuation of International Patent Application No. PCT/EP2011/056432 filed Apr. 21, 2011 and entitled “INFRARED RESOLUTION AND CONTRAST ENHANCEMENT WITH FUSION” which is hereby incorporated by reference in its entirety.

U.S. patent application Ser. No. 13/105,765 is also a continuation-in-part of U.S. patent application Ser. No. 12/766,739 which is hereby incorporated by reference in its entirety.

International Patent Application No. PCT/EP2011/056432 is a continuation-in-part of U.S. patent application Ser. No. 12/766,739 which is hereby incorporated by reference in its entirety.

International Patent Application No. PCT/EP2011/056432 also claims the benefit of U.S. Provisional Patent Application No. 61/473,207 which is hereby incorporated by reference in its entirety.

This application is a continuation-in-part of U.S. patent application Ser. No. 14/138,058 filed Dec. 21, 2013 and entitled “COMPACT MULTI-SPECTRUM IMAGING WITH FUSION” which is hereby incorporated by reference in its entirety.

U.S. patent application Ser. No. 14/138,058 claims the benefit of U.S. Provisional Patent Application No. 61/748,018 filed Dec. 31, 2012 and entitled “COMPACT MULTI-SPECTRUM IMAGING WITH FUSION” which is hereby incorporated by reference in its entirety.

This application is a continuation-in-part of U.S. patent application Ser. No. 14/299,987 filed Jun. 9, 2014 and entitled “INFRARED CAMERA SYSTEMS AND METHODS FOR DUAL SENSOR APPLICATIONS” which is hereby incorporated by reference in its entirety.

U.S. patent application Ser. No. 14/299,987 is a continuation of U.S. patent application Ser. No. 12/477,828 filed Jun. 3, 2009 and entitled “INFRARED CAMERA SYSTEMS AND METHODS FOR DUAL SENSOR APPLICATIONS” which is hereby incorporated by reference in its entirety.

This application is a continuation-in-part of U.S. patent application Ser. No. 14/138,040 filed Dec. 21, 2013 and entitled “TIME SPACED INFRARED IMAGE ENHANCEMENT” which is hereby incorporated by reference in its entirety.

U.S. patent application Ser. No. 14/138,040 claims the benefit of U.S. Provisional Patent Application No. 61/792,582 filed Mar. 15, 2013 and entitled “TIME SPACED INFRARED IMAGE ENHANCEMENT” which is hereby incorporated by reference in its entirety.

U.S. patent application Ser. No. 14/138,040 also claims the benefit of U.S. Provisional Patent Application No. 61/746,069 filed Dec. 26, 2012 and entitled “TIME SPACED INFRARED IMAGE ENHANCEMENT” which is hereby incorporated by reference in its entirety.

This application is a continuation-in-part of U.S. patent application Ser. No. 14/138,052 filed Dec. 21, 2013 and entitled “INFRARED IMAGING ENHANCEMENT WITH FUSION” which is hereby incorporated by reference in its entirety.

U.S. patent application Ser. No. 14/138,052 claims the benefit of U.S. Provisional Patent Application No. 61/793,952 filed Mar. 15, 2013 and entitled “INFRARED IMAGING ENHANCEMENT WITH FUSION” which is hereby incorporated by reference in its entirety.

U.S. patent application Ser. No. 14/138,052 also claims the benefit of U.S. Provisional Patent Application No. 61/746,074 filed Dec. 26, 2012 and entitled “INFRARED IMAGING ENHANCEMENT WITH FUSION” which is hereby incorporated by reference in its entirety.

### TECHNICAL FIELD

One or more embodiments of the invention relate generally to thermal imaging devices and more particularly, for example, to durable compact multisensor thermal imaging devices.

### BACKGROUND

First responders, law enforcement, and military personnel often face dangerous situations when required to enter an unknown environment that contains potential human or environmental threats.

Deployable cameras have been developed that can be thrown into this type of unknown environment to gather visible light pictures of the environment. Conventional deployable cameras include a charge-coupled-device camera sensor that can be coupled to fiber optic components or movable optics for taking pictures of the scene. However, these deployable cameras can be limited, particularly when visibility in the environment is diminished by smoke and/or lack of light.

Some conventional deployable cameras include a light source for illuminating a scene so that images can be captured. However, illumination of this type can be ineffective in, for example, a smoke-filled environment in which the illumination can simply brighten the smoke. Moreover, an illumination source can make the camera undesirably noticeable in situations in which the goal is to image and monitor humans such as enemy combatants in the environment.

It would therefore be desirable to provide improved deployable observation systems.

### SUMMARY

Various embodiments are disclosed for durable compact multisensor observation devices. A durable compact multisensor observation device may be a throwable imaging device that can withstand being thrown or otherwise projected into an environment to be observed and that can observe the environment in various possible resting positions. A throwable imaging device may be a throwable thermal imaging device. The throwable thermal imaging device may be a throwable imaging device having multiple infrared imaging modules mounted in a durable housing structure.

Each infrared imaging module may form a portion of an imaging module that also includes a visible light camera. In one embodiment, a plurality of imaging modules are mounted behind a corresponding plurality of openings in spherical or multi-sided durable housing structure. The durable housing structure may be formed from a material that can withstand an impact and, if desired, high temperature environments such as in or around burning structures or explosive devices. The durable housing structure may have a shape that increases the durability of the structure. The durable housing structure may have a compact size and weight that allow a person to pick up and throw the durable compact observation device into the environment to be observed. A durable compact multisensor observation device may sometimes be referred to herein as a durable compact observation device, a compact durable observation device, an observation device, a compact observation device, a durable observation device, a throwable imaging device, a throwable thermal imaging device, a thermal imager grenade, an imaging device, or simply as the device.

The durable housing structure may include weighting structures such as molded or machined features, internal weights, or other weighting or shaping features that help maximize the number of sensors with unblocked fields of view when the throwable imaging device is inserted into a hostile environment.

The throwable imaging device may include one or more proximity sensors. Proximity sensor data may be used to determine that some or all of the imaging modules may be powered down to conserve power (e.g., if some of the imaging modules are facing the ground).

The throwable imaging device may have one or more solar power pads that provide power for the device. The throwable imaging device may include motion sensor and positioning components for determining the location and orientation of the device such as global position system (GPS) components, accelerometers, gyroscopes, and compasses. The throwable imaging device may also include a processor and memory suitable for processing thermal and visible light image data captured using the imaging modules. The processor may be used to integrate status data from the motion sensor and positioning components with image data from the imaging modules to form stitched images with captured images from multiple imaging modules.

Imaging modules in the throwable imaging device may include infrared imaging modules that sense infrared radiation (e.g., infrared energy) from a target scene including, for example, mid wave infrared (MWIR) radiation, long wave infrared (LWIR) radiation, and/or radiation in other thermal imaging bands as may be desired in particular implementations. Imaging modules in the throwable imaging device may also include visible light cameras having sensors that respond to visible light such as red light, green light, and/or blue light, near infrared (NIR) light, and/or other wavelengths of light.

In one embodiment, a throwable imaging device may include imaging modules (e.g., SWIR imaging modules, MWIR imaging modules, LWIR imaging modules, or other infrared or visible light imaging modules) and other circuitry that are packaged within the durable housing structure so that the throwable imaging device can survive the shock, vibration, heat, and abuse of a hostile environment and can wirelessly transmit to a mobile handset of a remote user a high-quality full hemispherical LWIR thermal image that is geo-referenced to its final resting position.

In an embodiment, a throwable imaging device may include one or more chemical sensors. For example, the chemical sensors may include a gas sensor, such as a volatile organic compound (VOC) sensor, a humidity sensor, an oxygen sensor, a carbon dioxide sensor, a carbon monoxide sensor, or other gas sensor. In another example, the chemical sensors may include a biosensor to detect biological agents, a chemical agent detector to detect chemical agents, an explosives detector to detect explosive materials, and radiation detectors to detect radiation from radioactive material.

The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 illustrates an infrared imaging module configured to be implemented in a host device in accordance with an embodiment of the disclosure.

FIG. 2 illustrates an assembled infrared imaging module in accordance with an embodiment of the disclosure.

FIG. 3 illustrates an exploded view of an infrared imaging module juxtaposed over a socket in accordance with an embodiment of the disclosure.

FIG. 4 illustrates a block diagram of an infrared sensor assembly including an array of infrared sensors in accordance with an embodiment of the disclosure.

FIG. 5 illustrates a flow diagram of various operations to determine NUC terms in accordance with an embodiment of the disclosure.

FIG. 6 illustrates differences between neighboring pixels in accordance with an embodiment of the disclosure.

FIG. 7 illustrates a flat field correction technique in accordance with an embodiment of the disclosure.

FIG. 8 illustrates various image processing techniques of FIG. 5 and other operations applied in an image processing pipeline in accordance with an embodiment of the disclosure.

FIG. 9 illustrates a temporal noise reduction process in accordance with an embodiment of the disclosure.

FIG. 10 illustrates particular implementation details of several processes of the image processing pipeline of FIG. 6 in accordance with an embodiment of the disclosure.

FIG. 11 illustrates spatially correlated FPN in a neighborhood of pixels in accordance with an embodiment of the disclosure.

FIG. 12 illustrates a block diagram of another implementation of an infrared sensor assembly including an array of infrared sensors and a low-dropout regulator in accordance with an embodiment of the disclosure.

FIG. 13 illustrates a circuit diagram of a portion of the infrared sensor assembly of FIG. 12 in accordance with an embodiment of the disclosure.

FIG. 14 illustrates a block diagram of a host system having an infrared imaging module and a visible light camera in accordance with an embodiment of the disclosure.

FIG. 15 illustrates an example thermal image that may be captured using an infrared imaging module and analyzed by a processor in accordance with an embodiment of the disclosure.

FIG. 16 illustrates a process for combining thermal images and visible light images in accordance with an embodiment of the disclosure.

FIG. 17A illustrates a block diagram of a host system that is implemented as a durable compact multisensor observation device in accordance with an embodiment of the disclosure.

FIG. 17B illustrates a block diagram of a durable compact multisensor observation device showing various sensors that may be included in accordance with an embodiment of the disclosure.

FIG. 18 illustrates a system that includes a durable compact multisensor observation device and a mobile handset for receiving images from the observation device in accordance with an embodiment of the disclosure.

FIG. 19 illustrates a perspective view of a throwable imaging device having a plurality of imaging modules mounted behind openings in a durable housing structure in accordance with an embodiment of the disclosure.

FIG. 20 illustrates a cross-sectional view of a portion of the throwable imaging device of FIG. 19 in accordance with an embodiment of the disclosure.

FIG. 21 illustrates how a throwable imaging device may be inserted into a hostile environment by a person throwing the throwable imaging device in accordance with an embodiment of the disclosure.

FIG. 22 illustrates how a durable compact multisensor observation device may be inserted into a hostile environment by a projectile launcher in accordance with an embodiment of the disclosure.

FIG. 23 illustrates a process for using a durable compact multisensor observation device to observe a potentially hostile environment in accordance with an embodiment of the disclosure.

FIG. 24 illustrates a process for generating images using a durable compact multisensor observation device in accordance with an embodiment of the disclosure.

FIG. 25 illustrates a process for performing image processing operations using device status information with a durable compact multisensor observation device in accordance with an embodiment of the disclosure.

FIG. 26 illustrates a cross-sectional view of a portion of the throwable imaging device of FIG. 19 in the vicinity of internal weighting structures for the device in accordance with an embodiment of the disclosure.

Embodiments of the invention and their advantages are best understood by referring to the detailed description that follows. It should be appreciated that like reference numerals are used to identify like elements illustrated in one or more of the figures.

### DETAILED DESCRIPTION

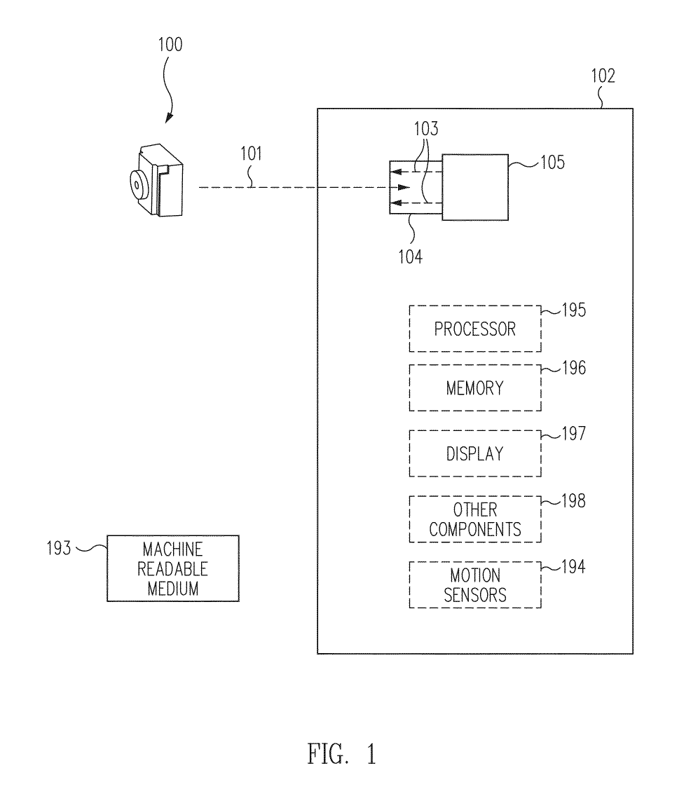

FIG. 1 illustrates an infrared imaging module 100 (e.g., an infrared camera or an infrared imaging device) configured to be implemented in a host device 102 in accordance with an embodiment of the disclosure. Infrared imaging module 100 may be implemented, for one or more embodiments, with a small form factor and in accordance with wafer level packaging techniques or other packaging techniques.

In one embodiment, infrared imaging module 100 may be configured to be implemented in a small portable host device 102, such as a mobile telephone, a tablet computing device, a laptop computing device, a personal digital assistant, a visible light camera, a music player, a throwable imaging device, or any other appropriate mobile device. In this regard, infrared imaging module 100 may be used to provide infrared imaging features to host device 102. For example, infrared imaging module 100 may be configured to capture, process, and/or otherwise manage infrared images and provide such infrared images to host device 102 for use in any desired fashion (e.g., for further processing, to store in memory, to display, to use by various applications running on host device 102, to export to other devices, or other uses).

In various embodiments, infrared imaging module 100 may be configured to operate at low voltage levels and over a wide temperature range. For example, in one embodiment, infrared imaging module 100 may operate using a power supply of approximately 2.4 volts, 2.5 volts, 2.8 volts, or lower voltages, and operate over a temperature range of approximately −20 degrees C. to approximately +60 degrees C. (e.g., providing a suitable dynamic range and performance over an environmental temperature range of approximately 80 degrees C.). In one embodiment, by operating infrared imaging module 100 at low voltage levels, infrared imaging module 100 may experience reduced amounts of self heating in comparison with other types of infrared imaging devices. As a result, infrared imaging module 100 may be operated with reduced measures to compensate for such self heating.

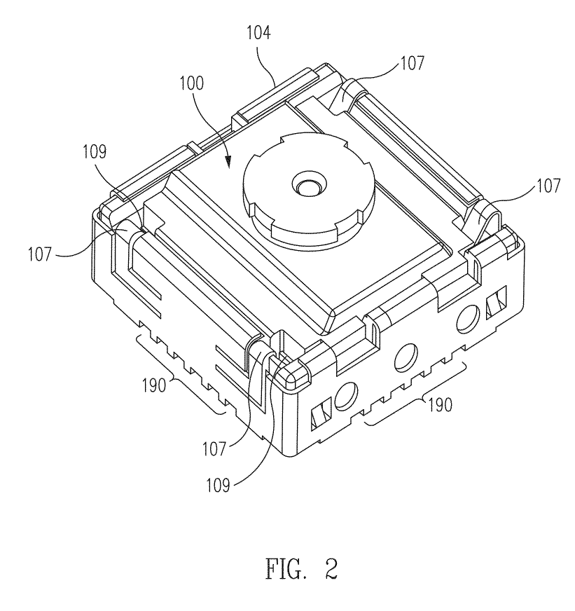

As shown in FIG. 1, host device 102 may include a socket 104, a shutter 105, motion sensors 194, a processor 195, a memory 196, a display 197, and/or other components 198. Socket 104 may be configured to receive infrared imaging module 100 as identified by arrow 101. In this regard, FIG. 2 illustrates infrared imaging module 100 assembled in socket 104 in accordance with an embodiment of the disclosure.

Motion sensors 194 may be implemented by one or more accelerometers, gyroscopes, or other appropriate devices that may be used to detect movement of host device 102. Motion sensors 194 may be monitored by and provide information to processing module 160 or processor 195 to detect motion. In various embodiments, motion sensors 194 may be implemented as part of host device 102 (as shown in FIG. 1), infrared imaging module 100, or other devices attached to or otherwise interfaced with host device 102.

Processor 195 may be implemented as any appropriate processing device (e.g., logic device, microcontroller, processor, application specific integrated circuit (ASIC), or other device) that may be used by host device 102 to execute appropriate instructions, such as software instructions provided in memory 196. Display 197 may be used to display captured and/or processed infrared images and/or other images, data, and information. Other components 198 may be used to implement any features of host device 102 as may be desired for various applications (e.g., clocks, temperature sensors, a visible light camera, or other components). In addition, a machine readable medium 193 may be provided for storing non-transitory instructions for loading into memory 196 and execution by processor 195.

In various embodiments, infrared imaging module 100 and socket 104 may be implemented for mass production to facilitate high volume applications, such as for implementation in mobile telephones or other devices (e.g., requiring small form factors). In one embodiment, the combination of infrared imaging module 100 and socket 104 may exhibit overall dimensions of approximately 8.5 mm by 8.5 mm by 5.9 mm while infrared imaging module 100 is installed in socket 104.

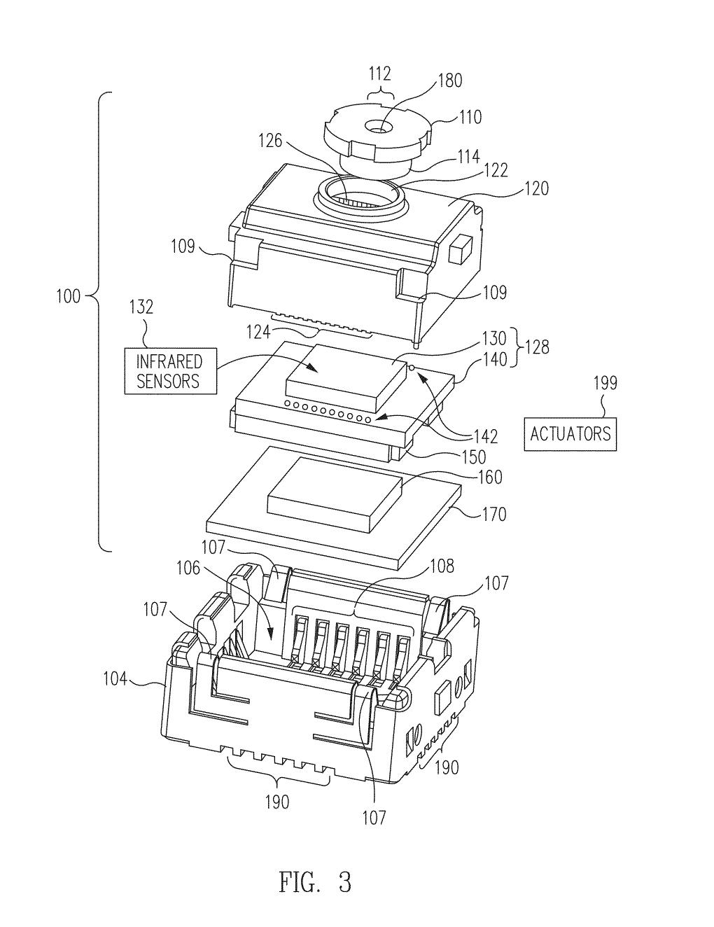

FIG. 3 illustrates an exploded view of infrared imaging module 100 juxtaposed over socket 104 in accordance with an embodiment of the disclosure. Infrared imaging module 100 may include a lens barrel 110, a housing 120, an infrared sensor assembly 128, a circuit board 170, a base 150, and a processing module 160.

Lens barrel 110 may at least partially enclose an optical element 180 (e.g., a lens) which is partially visible in FIG. 3 through an aperture 112 in lens barrel 110. Lens barrel 110 may include a substantially cylindrical extension 114 which may be used to interface lens barrel 110 with an aperture 122 in housing 120.

Infrared sensor assembly 128 may be implemented, for example, with a cap 130 (e.g., a lid) mounted on a substrate 140. Infrared sensor assembly 128 may include a plurality of infrared sensors 132 (e.g., infrared detectors) implemented in an array or other fashion on substrate 140 and covered by cap 130. For example, in one embodiment, infrared sensor assembly 128 may be implemented as a focal plane array (FPA). Such a focal plane array may be implemented, for example, as a vacuum package assembly (e.g., sealed by cap 130 and substrate 140). In one embodiment, infrared sensor assembly 128 may be implemented as a wafer level package (e.g., infrared sensor assembly 128 may be singulated from a set of vacuum package assemblies provided on a wafer). In one embodiment, infrared sensor assembly 128 may be implemented to operate using a power supply of approximately 2.4 volts, 2.5 volts, 2.8 volts, or similar voltages.

Infrared sensors 132 may be configured to detect infrared radiation (e.g., infrared energy) from a target scene including, for example, mid wave infrared wave bands (MWIR), long wave infrared wave bands (LWIR), and/or other thermal imaging bands as may be desired in particular implementations. In one embodiment, infrared sensor assembly 128 may be provided in accordance with wafer level packaging techniques.

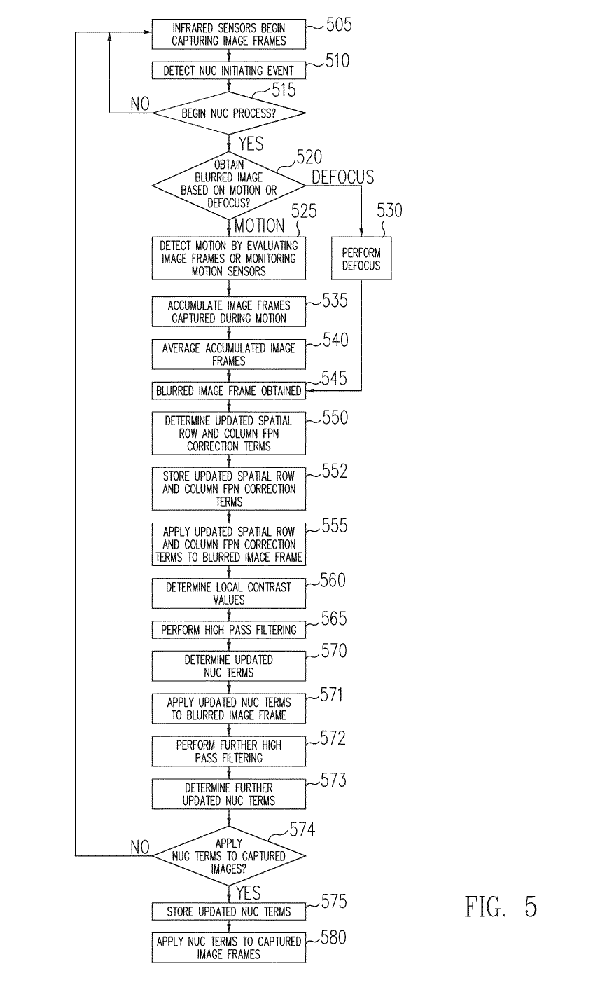

Infrared sensors 132 may be implemented, for example, as microbolometers or other types of thermal imaging infrared sensors arranged in any desired array pattern to provide a plurality of pixels. In one embodiment, infrared sensors 132 may be implemented as vanadium oxide (VOx) detectors with a 17 μm pixel pitch. In various embodiments, arrays of approximately 32 by 32 infrared sensors 132, approximately 64 by 64 infrared sensors 132, approximately 80 by 64 infrared sensors 132, or other array sizes may be used. Substrate 140 may include various circuitry including, for example, a read out integrated circuit (ROIC) with dimensions less than approximately 5.5 mm by 5.5 mm in one embodiment. Substrate 140 may also include bond pads 142 that may be used to contact complementary connections positioned on inside surfaces of housing 120 when infrared imaging module 100 is assembled as shown in FIGS. 5A, 5B, and 5C. In one embodiment, the ROIC may be implemented with low-dropout regulators (LDO) to perform voltage regulation to reduce power supply noise introduced to infrared sensor assembly 128 and thus provide an improved power supply rejection ratio (PSRR). Moreover, by implementing the LDO with the ROIC (e.g., within a wafer level package), less die area may be consumed and fewer discrete die (or chips) are needed.

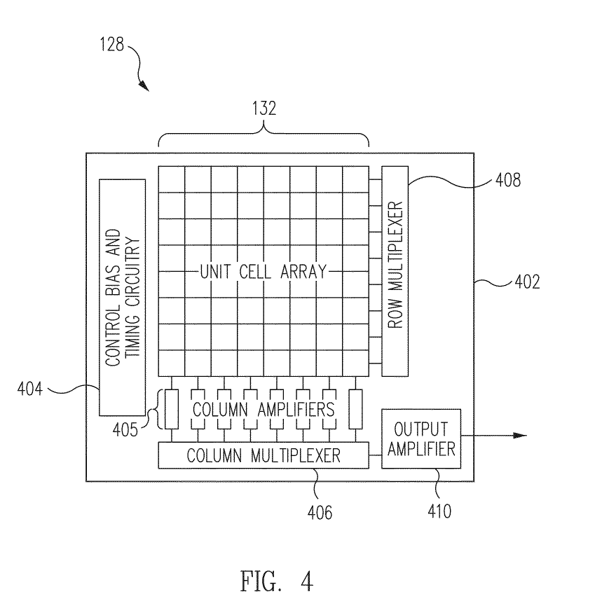

FIG. 4 illustrates a block diagram of infrared sensor assembly 128 including an array of infrared sensors 132 in accordance with an embodiment of the disclosure. In the illustrated embodiment, infrared sensors 132 are provided as part of a unit cell array of a ROIC 402. ROIC 402 includes bias generation and timing control circuitry 404, column amplifiers 405, a column multiplexer 406, a row multiplexer 408, and an output amplifier 410. Image frames (e.g., thermal images) captured by infrared sensors 132 may be provided by output amplifier 410 to processing module 160, processor 195, and/or any other appropriate components to perform various processing techniques described herein. Although an 8 by 8 array is shown in FIG. 4, any desired array configuration may be used in other embodiments. Further descriptions of ROICs and infrared sensors (e.g., microbolometer circuits) may be found in U.S. Pat. No. 6,028,309 issued Feb. 22, 2000, which is incorporated herein by reference in its entirety.

Infrared sensor assembly 128 may capture images (e.g., image frames) and provide such images from its ROIC at various rates. Processing module 160 may be used to perform appropriate processing of captured infrared images and may be implemented in accordance with any appropriate architecture. In one embodiment, processing module 160 may be implemented as an ASIC. In this regard, such an ASIC may be configured to perform image processing with high performance and/or high efficiency. In another embodiment, processing module 160 may be implemented with a general purpose central processing unit (CPU) which may be configured to execute appropriate software instructions to perform image processing, coordinate and perform image processing with various image processing blocks, coordinate interfacing between processing module 160 and host device 102, and/or other operations. In yet another embodiment, processing module 160 may be implemented with a field programmable gate array (FPGA). Processing module 160 may be implemented with other types of processing and/or logic circuits in other embodiments as would be understood by one skilled in the art.

In these and other embodiments, processing module 160 may also be implemented with other components where appropriate, such as, volatile memory, non-volatile memory, and/or one or more interfaces (e.g., infrared detector interfaces, inter-integrated circuit (12C) interfaces, mobile industry processor interfaces (MIPI), joint test action group (JTAG) interfaces (e.g., IEEE 1149.1 standard test access port and boundary-scan architecture), and/or other interfaces).

In some embodiments, infrared imaging module 100 may further include one or more actuators 199 which may be used to adjust the focus of infrared image frames captured by infrared sensor assembly 128. For example, actuators 199 may be used to move optical element 180, infrared sensors 132, and/or other components relative to each other to selectively focus and defocus infrared image frames in accordance with techniques described herein. Actuators 199 may be implemented in accordance with any type of motion-inducing apparatus or mechanism, and may positioned at any location within or external to infrared imaging module 100 as appropriate for different applications.

When infrared imaging module 100 is assembled, housing 120 may substantially enclose infrared sensor assembly 128, base 150, and processing module 160. Housing 120 may facilitate connection of various components of infrared imaging module 100. For example, in one embodiment, housing 120 may provide electrical connections 126 to connect various components as further described.

Electrical connections 126 (e.g., conductive electrical paths, traces, or other types of connections) may be electrically connected with bond pads 142 when infrared imaging module 100 is assembled. In various embodiments, electrical connections 126 may be embedded in housing 120, provided on inside surfaces of housing 120, and/or otherwise provided by housing 120. Electrical connections 126 may terminate in connections 124 protruding from the bottom surface of housing 120 as shown in FIG. 3. Connections 124 may connect with circuit board 170 when infrared imaging module 100 is assembled (e.g., housing 120 may rest atop circuit board 170 in various embodiments). Processing module 160 may be electrically connected with circuit board 170 through appropriate electrical connections. As a result, infrared sensor assembly 128 may be electrically connected with processing module 160 through, for example, conductive electrical paths provided by: bond pads 142, complementary connections on inside surfaces of housing 120, electrical connections 126 of housing 120, connections 124, and circuit board 170. Advantageously, such an arrangement may be implemented without requiring wire bonds to be provided between infrared sensor assembly 128 and processing module 160.

In various embodiments, electrical connections 126 in housing 120 may be made from any desired material (e.g., copper or any other appropriate conductive material). In one embodiment, electrical connections 126 may aid in dissipating heat from infrared imaging module 100.

Other connections may be used in other embodiments. For example, in one embodiment, sensor assembly 128 may be attached to processing module 160 through a ceramic board that connects to sensor assembly 128 by wire bonds and to processing module 160 by a ball grid array (BGA). In another embodiment, sensor assembly 128 may be mounted directly on a rigid flexible board and electrically connected with wire bonds, and processing module 160 may be mounted and connected to the rigid flexible board with wire bonds or a BGA.

The various implementations of infrared imaging module 100 and host device 102 set forth herein are provided for purposes of example, rather than limitation. In this regard, any of the various techniques described herein may be applied to any infrared camera system, infrared imager, or other device for performing infrared/thermal imaging.

Substrate 140 of infrared sensor assembly 128 may be mounted on base 150. In various embodiments, base 150 (e.g., a pedestal) may be made, for example, of copper formed by metal injection molding (MIM) and provided with a black oxide or nickel-coated finish. In various embodiments, base 150 may be made of any desired material, such as for example zinc, aluminum, or magnesium, as desired for a given application and may be formed by any desired applicable process, such as for example aluminum casting, MIM, or zinc rapid casting, as may be desired for particular applications. In various embodiments, base 150 may be implemented to provide structural support, various circuit paths, thermal heat sink properties, and other features where appropriate. In one embodiment, base 150 may be a multi-layer structure implemented at least in part using ceramic material.

In various embodiments, circuit board 170 may receive housing 120 and thus may physically support the various components of infrared imaging module 100. In various embodiments, circuit board 170 may be implemented as a printed circuit board (e.g., an FR4 circuit board or other types of circuit boards), a rigid or flexible interconnect (e.g., tape or other type of interconnects), a flexible circuit substrate, a flexible plastic substrate, or other appropriate structures. In various embodiments, base 150 may be implemented with the various features and attributes described for circuit board 170, and vice versa.

Socket 104 may include a cavity 106 configured to receive infrared imaging module 100 (e.g., as shown in the assembled view of FIG. 2). Infrared imaging module 100 and/or socket 104 may include appropriate tabs, arms, pins, fasteners, or any other appropriate engagement members which may be used to secure infrared imaging module 100 to or within socket 104 using friction, tension, adhesion, and/or any other appropriate manner. Socket 104 may include engagement members 107 that may engage surfaces 109 of housing 120 when infrared imaging module 100 is inserted into a cavity 106 of socket 104. Other types of engagement members may be used in other embodiments.

Infrared imaging module 100 may be electrically connected with socket 104 through appropriate electrical connections (e.g., contacts, pins, wires, or any other appropriate connections). For example, socket 104 may include electrical connections 108 which may contact corresponding electrical connections of infrared imaging module 100 (e.g., interconnect pads, contacts, or other electrical connections on side or bottom surfaces of circuit board 170, bond pads 142 or other electrical connections on base 150, or other connections). Electrical connections 108 may be made from any desired material (e.g., copper or any other appropriate conductive material). In one embodiment, electrical connections 108 may be mechanically biased to press against electrical connections of infrared imaging module 100 when infrared imaging module 100 is inserted into cavity 106 of socket 104. In one embodiment, electrical connections 108 may at least partially secure infrared imaging module 100 in socket 104. Other types of electrical connections may be used in other embodiments.

Socket 104 may be electrically connected with host device 102 through similar types of electrical connections. For example, in one embodiment, host device 102 may include electrical connections (e.g., soldered connections, snap-in connections, or other connections) that connect with electrical connections 108 passing through apertures 190. In various embodiments, such electrical connections may be made to the sides and/or bottom of socket 104.

Various components of infrared imaging module 100 may be implemented with flip chip technology which may be used to mount components directly to circuit boards without the additional clearances typically needed for wire bond connections. Flip chip connections may be used, as an example, to reduce the overall size of infrared imaging module 100 for use in compact small form factor applications. For example, in one embodiment, processing module 160 may be mounted to circuit board 170 using flip chip connections. For example, infrared imaging module 100 may be implemented with such flip chip configurations.

In various embodiments, infrared imaging module 100 and/or associated components may be implemented in accordance with various techniques (e.g., wafer level packaging techniques) as set forth in U.S. patent application Ser. No. 12/844,124 filed Jul. 27, 2010, and U.S. Provisional Patent Application No. 61/469,651 filed Mar. 30, 2011, which are incorporated herein by reference in their entirety. Furthermore, in accordance with one or more embodiments, infrared imaging module 100 and/or associated components may be implemented, calibrated, tested, and/or used in accordance with various techniques, such as for example as set forth in U.S. Pat. No. 7,470,902 issued Dec. 30, 2008, U.S. Pat. No. 6,028,309 issued Feb. 22, 2000, U.S. Pat. No. 6,812,465 issued Nov. 2, 2004, U.S. Pat. No. 7,034,301 issued Apr. 25, 2006, U.S. Pat. No. 7,679,048 issued Mar. 16, 2010, U.S. Pat. No. 7,470,904 issued Dec. 30, 2008, U.S. patent application Ser. No. 12/202,880 filed Sep. 2, 2008, and U.S. patent application Ser. No. 12/202,896 filed Sep. 2, 2008, which are incorporated herein by reference in their entirety.

Referring again to FIG. 1, in various embodiments, host device 102 may include shutter 105. In this regard, shutter 105 may be selectively positioned over socket 104 (e.g., as identified by arrows 103) while infrared imaging module 100 is installed therein. In this regard, shutter 105 may be used, for example, to protect infrared imaging module 100 when not in use. Shutter 105 may also be used as a temperature reference as part of a calibration process (e.g., a NUC process or other calibration processes) for infrared imaging module 100 as would be understood by one skilled in the art.

In various embodiments, shutter 105 may be made from various materials such as, for example, polymers, glass, aluminum (e.g., painted or anodized) or other materials. In various embodiments, shutter 105 may include one or more coatings to selectively filter electromagnetic radiation and/or adjust various optical properties of shutter 105 (e.g., a uniform blackbody coating or a reflective gold coating).

In another embodiment, shutter 105 may be fixed in place to protect infrared imaging module 100 at all times. In this case, shutter 105 or a portion of shutter 105 may be made from appropriate materials (e.g., polymers or infrared transmitting materials such as silicon, germanium, zinc selenide, or chalcogenide glasses) that do not substantially filter desired infrared wavelengths. In another embodiment, a shutter may be implemented as part of infrared imaging module 100 (e.g., within or as part of a lens barrel or other components of infrared imaging module 100), as would be understood by one skilled in the art.

Alternatively, in another embodiment, a shutter (e.g., shutter 105 or other type of external or internal shutter) need not be provided, but rather a NUC process or other type of calibration may be performed using shutterless techniques. In another embodiment, a NUC process or other type of calibration using shutterless techniques may be performed in combination with shutter-based techniques.

Infrared imaging module 100 and host device 102 may be implemented in accordance with any of the various techniques set forth in U.S. Provisional Patent Application No. 61/495,873 filed Jun. 10, 2011, U.S. Provisional Patent Application No. 61/495,879 filed Jun. 10, 2011, and U.S. Provisional Patent Application No. 61/495,888 filed Jun. 10, 2011, which are incorporated herein by reference in their entirety.

In various embodiments, the components of host device 102 and/or infrared imaging module 100 may be implemented as a local or distributed system with components in communication with each other over wired and/or wireless networks. Accordingly, the various operations identified in this disclosure may be performed by local and/or remote components as may be desired in particular implementations.

FIG. 5 illustrates a flow diagram of various operations to determine NUC terms in accordance with an embodiment of the disclosure. In some embodiments, the operations of FIG. 5 may be performed by processing module 160 or processor 195 (both also generally referred to as a processor) operating on image frames captured by infrared sensors 132.

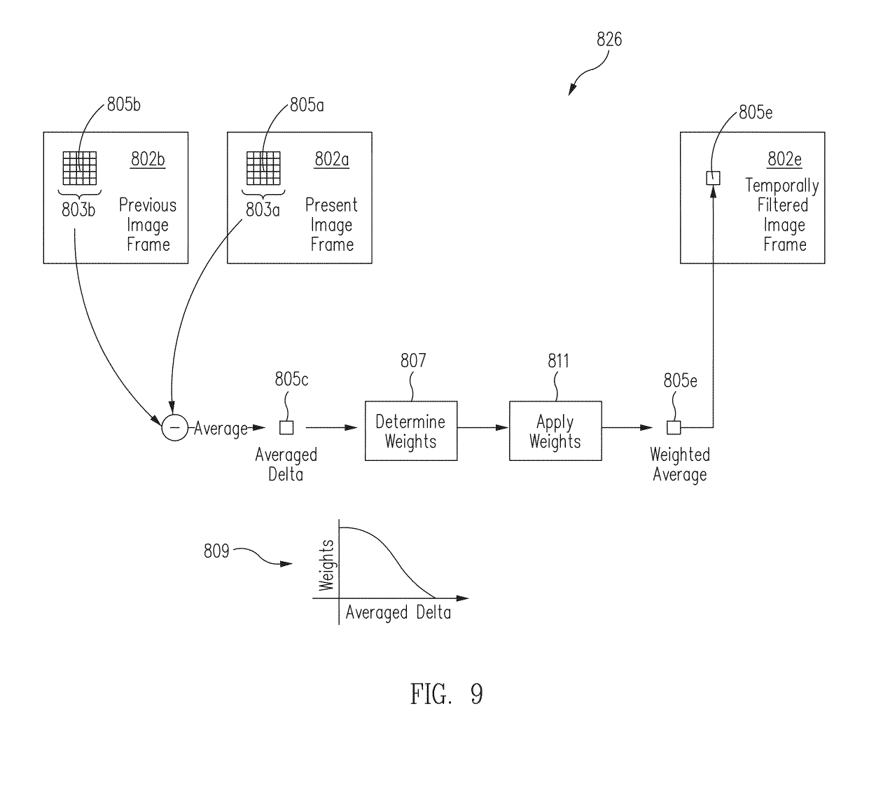

In block 505, infrared sensors 132 begin capturing image frames of a scene. Typically, the scene will be a portion of the real world environment in which host device 102 is currently located. In this regard, shutter 105 (if optionally provided) may be opened to permit infrared imaging module to receive infrared radiation from the scene. Infrared sensors 132 may continue capturing image frames during all operations shown in FIG. 5. In this regard, the continuously captured image frames may be used for various operations as further discussed. In one embodiment, the captured image frames may be temporally filtered (e.g., in accordance with the process of block 826 further described herein with regard to FIG. 8) and be processed by other terms (e.g., factory gain terms 812, factory offset terms 816, previously determined NUC terms 817, column FPN terms 820, and row FPN terms 824 as further described herein with regard to FIG. 8) before they are used in the operations shown in FIG. 5.

In block 510, a NUC process initiating event is detected. In one embodiment, the NUC process may be initiated in response to physical movement of host device 102. Such movement may be detected, for example, by motion sensors 194 which may be polled by a processor. In one example, a user may move host device 102 in a particular manner, such as by intentionally waving host device 102 back and forth in an “erase” or “swipe” movement. In this regard, the user may move host device 102 in accordance with a predetermined speed and direction (velocity), such as in an up and down, side to side, or other pattern to initiate the NUC process. In this example, the use of such movements may permit the user to intuitively operate host device 102 to simulate the “erasing” of noise in captured image frames.

In another example, a NUC process may be initiated by host device 102 if motion exceeding a threshold value is exceeded (e.g., motion greater than expected for ordinary use). It is contemplated that any desired type of spatial translation of host device 102 may be used to initiate the NUC process.

In yet another example, a NUC process may be initiated by host device 102 if a minimum time has elapsed since a previously performed NUC process. In a further example, a NUC process may be initiated by host device 102 if infrared imaging module 100 has experienced a minimum temperature change since a previously performed NUC process. In a still further example, a NUC process may be continuously initiated and repeated.

In block 515, after a NUC process initiating event is detected, it is determined whether the NUC process should actually be performed. In this regard, the NUC process may be selectively initiated based on whether one or more additional conditions are met. For example, in one embodiment, the NUC process may not be performed unless a minimum time has elapsed since a previously performed NUC process. In another embodiment, the NUC process may not be performed unless infrared imaging module 100 has experienced a minimum temperature change since a previously performed NUC process. Other criteria or conditions may be used in other embodiments. If appropriate criteria or conditions have been met, then the flow diagram continues to block 520. Otherwise, the flow diagram returns to block 505.

In the NUC process, blurred image frames may be used to determine NUC terms which may be applied to captured image frames to correct for FPN. As discussed, in one embodiment, the blurred image frames may be obtained by accumulating multiple image frames of a moving scene (e.g., captured while the scene and/or the thermal imager is in motion). In another embodiment, the blurred image frames may be obtained by defocusing an optical element or other component of the thermal imager.

Accordingly, in block 520 a choice of either approach is provided. If the motion-based approach is used, then the flow diagram continues to block 525. If the defocus-based approach is used, then the flow diagram continues to block 530.

Referring now to the motion-based approach, in block 525 motion is detected. For example, in one embodiment, motion may be detected based on the image frames captured by infrared sensors 132. In this regard, an appropriate motion detection process (e.g., an image registration process, a frame-to-frame difference calculation, or other appropriate process) may be applied to captured image frames to determine whether motion is present (e.g., whether static or moving image frames have been captured). For example, in one embodiment, it can be determined whether pixels or regions around the pixels of consecutive image frames have changed more than a user defined amount (e.g., a percentage and/or threshold value). If at least a given percentage of pixels have changed by at least the user defined amount, then motion will be detected with sufficient certainty to proceed to block 535.

In another embodiment, motion may be determined on a per pixel basis, wherein only pixels that exhibit significant changes are accumulated to provide the blurred image frame. For example, counters may be provided for each pixel and used to ensure that the same number of pixel values are accumulated for each pixel, or used to average the pixel values based on the number of pixel values actually accumulated for each pixel. Other types of image-based motion detection may be performed such as performing a Radon transform.

In another embodiment, motion may be detected based on data provided by motion sensors 194. In one embodiment, such motion detection may include detecting whether host device 102 is moving along a relatively straight trajectory through space. For example, if host device 102 is moving along a relatively straight trajectory, then it is possible that certain objects appearing in the imaged scene may not be sufficiently blurred (e.g., objects in the scene that may be aligned with or moving substantially parallel to the straight trajectory). Thus, in such an embodiment, the motion detected by motion sensors 194 may be conditioned on host device 102 exhibiting, or not exhibiting, particular trajectories.

In yet another embodiment, both a motion detection process and motion sensors 194 may be used. Thus, using any of these various embodiments, a determination can be made as to whether or not each image frame was captured while at least a portion of the scene and host device 102 were in motion relative to each other (e.g., which may be caused by host device 102 moving relative to the scene, at least a portion of the scene moving relative to host device 102, or both).

It is expected that the image frames for which motion was detected may exhibit some secondary blurring of the captured scene (e.g., blurred thermal image data associated with the scene) due to the thermal time constants of infrared sensors 132 (e.g., microbolometer thermal time constants) interacting with the scene movement.

In block 535, image frames for which motion was detected are accumulated. For example, if motion is detected for a continuous series of image frames, then the image frames of the series may be accumulated. As another example, if motion is detected for only some image frames, then the non-moving image frames may be skipped and not included in the accumulation. Thus, a continuous or discontinuous set of image frames may be selected to be accumulated based on the detected motion.

In block 540, the accumulated image frames are averaged to provide a blurred image frame. Because the accumulated image frames were captured during motion, it is expected that actual scene information will vary between the image frames and thus cause the scene information to be further blurred in the resulting blurred image frame (block 545).

In contrast, FPN (e.g., caused by one or more components of infrared imaging module 100) will remain fixed over at least short periods of time and over at least limited changes in scene irradiance during motion. As a result, image frames captured in close proximity in time and space during motion will suffer from identical or at least very similar FPN. Thus, although scene information may change in consecutive image frames, the FPN will stay essentially constant. By averaging, multiple image frames captured during motion will blur the scene information, but will not blur the FPN. As a result, FPN will remain more clearly defined in the blurred image frame provided in block 545 than the scene information.

In one embodiment, 32 or more image frames are accumulated and averaged in blocks 535 and 540. However, any desired number of image frames may be used in other embodiments, but with generally decreasing correction accuracy as frame count is decreased.

Referring now to the defocus-based approach, in block 530, a defocus operation may be performed to intentionally defocus the image frames captured by infrared sensors 132. For example, in one embodiment, one or more actuators 199 may be used to adjust, move, or otherwise translate optical element 180, infrared sensor assembly 128, and/or other components of infrared imaging module 100 to cause infrared sensors 132 to capture a blurred (e.g., unfocused) image frame of the scene. Other non-actuator based techniques are also contemplated for intentionally defocusing infrared image frames such as, for example, manual (e.g., user-initiated) defocusing.

Although the scene may appear blurred in the image frame, FPN (e.g., caused by one or more components of infrared imaging module 100) will remain unaffected by the defocusing operation. As a result, a blurred image frame of the scene will be provided (block 545) with FPN remaining more clearly defined in the blurred image than the scene information.

In the above discussion, the defocus-based approach has been described with regard to a single captured image frame. In another embodiment, the defocus-based approach may include accumulating multiple image frames while the infrared imaging module 100 has been defocused and averaging the defocused image frames to remove the effects of temporal noise and provide a blurred image frame in block 545.

Thus, it will be appreciated that a blurred image frame may be provided in block 545 by either the motion-based approach or the defocus-based approach. Because much of the scene information will be blurred by either motion, defocusing, or both, the blurred image frame may be effectively considered a low pass filtered version of the original captured image frames with respect to scene information.

In block 550, the blurred image frame is processed to determine updated row and column FPN terms (e.g., if row and column FPN terms have not been previously determined then the updated row and column FPN terms may be new row and column FPN terms in the first iteration of block 550). As used in this disclosure, the terms row and column may be used interchangeably depending on the orientation of infrared sensors 132 and/or other components of infrared imaging module 100.

In one embodiment, block 550 includes determining a spatial FPN correction term for each row of the blurred image frame (e.g., each row may have its own spatial FPN correction term), and also determining a spatial FPN correction term for each column of the blurred image frame (e.g., each column may have its own spatial FPN correction term). Such processing may be used to reduce the spatial and slowly varying (1/f) row and column FPN inherent in thermal imagers caused by, for example, 1/f noise characteristics of amplifiers in ROIC 402 which may manifest as vertical and horizontal stripes in image frames.

Advantageously, by determining spatial row and column FPN terms using the blurred image frame, there will be a reduced risk of vertical and horizontal objects in the actual imaged scene from being mistaken for row and column noise (e.g., real scene content will be blurred while FPN remains unblurred).

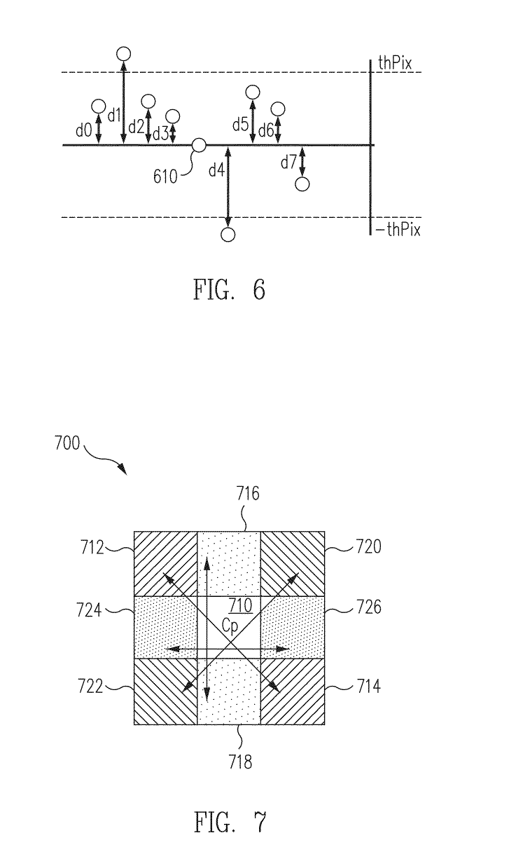

In one embodiment, row and column FPN terms may be determined by considering differences between neighboring pixels of the blurred image frame. For example, FIG. 6 illustrates differences between neighboring pixels in accordance with an embodiment of the disclosure. Specifically, in FIG. 6 a pixel 610 is compared to its 8 nearest horizontal neighbors: d0-d3 on one side and d4-d7 on the other side. Differences between the neighbor pixels can be averaged to obtain an estimate of the offset error of the illustrated group of pixels. An offset error may be calculated for each pixel in a row or column and the average result may be used to correct the entire row or column.

To prevent real scene data from being interpreted as noise, upper and lower threshold values may be used (thPix and −thPix). Pixel values falling outside these threshold values (pixels d1 and d4 in this example) are not used to obtain the offset error. In addition, the maximum amount of row and column FPN correction may be limited by these threshold values.

Further techniques for performing spatial row and column FPN correction processing are set forth in U.S. patent application Ser. No. 12/396,340 filed Mar. 2, 2009 which is incorporated herein by reference in its entirety.

Referring again to FIG. 5, the updated row and column FPN terms determined in block 550 are stored (block 552) and applied (block 555) to the blurred image frame provided in block 545. After these terms are applied, some of the spatial row and column FPN in the blurred image frame may be reduced. However, because such terms are applied generally to rows and columns, additional FPN may remain such as spatially uncorrelated FPN associated with pixel to pixel drift or other causes. Neighborhoods of spatially correlated FPN may also remain which may not be directly associated with individual rows and columns. Accordingly, further processing may be performed as discussed below to determine NUC terms.

In block 560, local contrast values (e.g., edges or absolute values of gradients between adjacent or small groups of pixels) in the blurred image frame are determined. If scene information in the blurred image frame includes contrasting areas that have not been significantly blurred (e.g., high contrast edges in the original scene data), then such features may be identified by a contrast determination process in block 560.

For example, local contrast values in the blurred image frame may be calculated, or any other desired type of edge detection process may be applied to identify certain pixels in the blurred image as being part of an area of local contrast. Pixels that are marked in this manner may be considered as containing excessive high spatial frequency scene information that would be interpreted as FPN (e.g., such regions may correspond to portions of the scene that have not been sufficiently blurred). As such, these pixels may be excluded from being used in the further determination of NUC terms. In one embodiment, such contrast detection processing may rely on a threshold that is higher than the expected contrast value associated with FPN (e.g., pixels exhibiting a contrast value higher than the threshold may be considered to be scene information, and those lower than the threshold may be considered to be exhibiting FPN).

In one embodiment, the contrast determination of block 560 may be performed on the blurred image frame after row and column FPN terms have been applied to the blurred image frame (e.g., as shown in FIG. 5). In another embodiment, block 560 may be performed prior to block 550 to determine contrast before row and column FPN terms are determined (e.g., to prevent scene based contrast from contributing to the determination of such terms).

Following block 560, it is expected that any high spatial frequency content remaining in the blurred image frame may be generally attributed to spatially uncorrelated FPN. In this regard, following block 560, much of the other noise or actual desired scene based information has been removed or excluded from the blurred image frame due to: intentional blurring of the image frame (e.g., by motion or defocusing in blocks 520 through 545), application of row and column FPN terms (block 555), and contrast determination (block 560).

Thus, it can be expected that following block 560, any remaining high spatial frequency content (e.g., exhibited as areas of contrast or differences in the blurred image frame) may be attributed to spatially uncorrelated FPN. Accordingly, in block 565, the blurred image frame is high pass filtered. In one embodiment, this may include applying a high pass filter to extract the high spatial frequency content from the blurred image frame. In another embodiment, this may include applying a low pass filter to the blurred image frame and taking a difference between the low pass filtered image frame and the unfiltered blurred image frame to obtain the high spatial frequency content. In accordance with various embodiments of the present disclosure, a high pass filter may be implemented by calculating a mean difference between a sensor signal (e.g., a pixel value) and its neighbors.

In block 570, a flat field correction process is performed on the high pass filtered blurred image frame to determine updated NUC terms (e.g., if a NUC process has not previously been performed then the updated NUC terms may be new NUC terms in the first iteration of block 570).

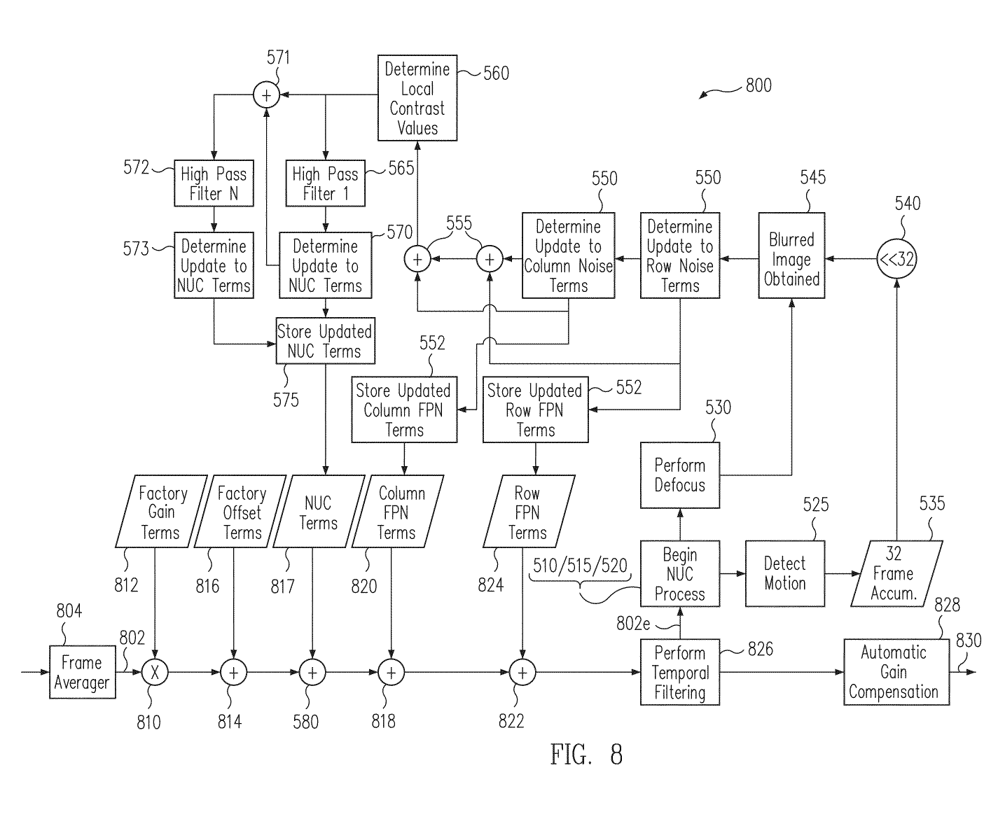

For example, FIG. 7 illustrates a flat field correction technique 700 in accordance with an embodiment of the disclosure. In FIG. 7, a NUC term may be determined for each pixel 710 of the blurred image frame using the values of its neighboring pixels 712 to 726. For each pixel 710, several gradients may be determined based on the absolute difference between the values of various adjacent pixels. For example, absolute value differences may be determined between: pixels 712 and 714 (a left to right diagonal gradient), pixels 716 and 718 (a top to bottom vertical gradient), pixels 720 and 722 (a right to left diagonal gradient), and pixels 724 and 726 (a left to right horizontal gradient).

These absolute differences may be summed to provide a summed gradient for pixel 710. A weight value may be determined for pixel 710 that is inversely proportional to the summed gradient. This process may be performed for all pixels 710 of the blurred image frame until a weight value is provided for each pixel 710. For areas with low gradients (e.g., areas that are blurry or have low contrast), the weight value will be close to one. Conversely, for areas with high gradients, the weight value will be zero or close to zero. The update to the NUC term as estimated by the high pass filter is multiplied with the weight value.

In one embodiment, the risk of introducing scene information into the NUC terms can be further reduced by applying some amount of temporal damping to the NUC term determination process. For example, a temporal damping factor λ between 0 and 1 may be chosen such that the new NUC term (NUC_{NEW}) stored is a weighted average of the old NUC term (NUC_{OLD}) and the estimated updated NUC term (NUC_{UPDATE}). In one embodiment, this can be expressed as NUC_{NEW}=λ·NUC_{OLD}+(1−λ)·(NUC_{OLD}+NUC_{UPDATE}).

Although the determination of NUC terms has been described with regard to gradients, local contrast values may be used instead where appropriate. Other techniques may also be used such as, for example, standard deviation calculations. Other types flat field correction processes may be performed to determine NUC terms including, for example, various processes identified in U.S. Pat. No. 6,028,309 issued Feb. 22, 2000, U.S. Pat. No. 6,812,465 issued Nov. 2, 2004, and U.S. patent application Ser. No. 12/114,865 filed May 5, 2008, which are incorporated herein by reference in their entirety.

Referring again to FIG. 5, block 570 may include additional processing of the NUC terms. For example, in one embodiment, to preserve the scene signal mean, the sum of all NUC terms may be normalized to zero by subtracting the NUC term mean from each NUC term. Also in block 570, to avoid row and column noise from affecting the NUC terms, the mean value of each row and column may be subtracted from the NUC terms for each row and column. As a result, row and column FPN filters using the row and column FPN terms determined in block 550 may be better able to filter out row and column noise in further iterations (e.g., as further shown in FIG. 8) after the NUC terms are applied to captured images (e.g., in block 580 further discussed herein). In this regard, the row and column FPN filters may in general use more data to calculate the per row and per column offset coefficients (e.g., row and column FPN terms) and may thus provide a more robust alternative for reducing spatially correlated FPN than the NUC terms which are based on high pass filtering to capture spatially uncorrelated noise.

In blocks 571-573, additional high pass filtering and further determinations of updated NUC terms may be optionally performed to remove spatially correlated FPN with lower spatial frequency than previously removed by row and column FPN terms. In this regard, some variability in infrared sensors 132 or other components of infrared imaging module 100 may result in spatially correlated FPN noise that cannot be easily modeled as row or column noise. Such spatially correlated FPN may include, for example, window defects on a sensor package or a cluster of infrared sensors 132 that respond differently to irradiance than neighboring infrared sensors 132. In one embodiment, such spatially correlated FPN may be mitigated with an offset correction. If the amount of such spatially correlated FPN is significant, then the noise may also be detectable in the blurred image frame. Since this type of noise may affect a neighborhood of pixels, a high pass filter with a small kernel may not detect the FPN in the neighborhood (e.g., all values used in high pass filter may be taken from the neighborhood of affected pixels and thus may be affected by the same offset error). For example, if the high pass filtering of block 565 is performed with a small kernel (e.g., considering only immediately adjacent pixels that fall within a neighborhood of pixels affected by spatially correlated FPN), then broadly distributed spatially correlated FPN may not be detected.

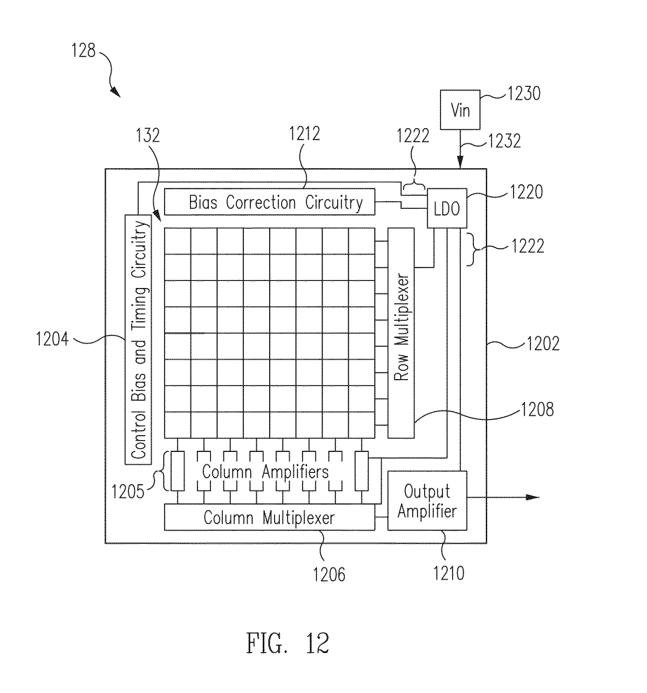

For example, FIG. 11 illustrates spatially correlated FPN in a neighborhood of pixels in accordance with an embodiment of the disclosure. As shown in a sample image frame 1100, a neighborhood of pixels 1110 may exhibit spatially correlated FPN that is not precisely correlated to individual rows and columns and is distributed over a neighborhood of several pixels (e.g., a neighborhood of approximately 4 by 4 pixels in this example). Sample image frame 1100 also includes a set of pixels 1120 exhibiting substantially uniform response that are not used in filtering calculations, and a set of pixels 1130 that are used to estimate a low pass value for the neighborhood of pixels 1110. In one embodiment, pixels 1130 may be a number of pixels divisible by two in order to facilitate efficient hardware or software calculations.

Referring again to FIG. 5, in blocks 571-573, additional high pass filtering and further determinations of updated NUC terms may be optionally performed to remove spatially correlated FPN such as exhibited by pixels 1110. In block 571, the updated NUC terms determined in block 570 are applied to the blurred image frame. Thus, at this time, the blurred image frame will have been initially corrected for spatially correlated FPN (e.g., by application of the updated row and column FPN terms in block 555), and also initially corrected for spatially uncorrelated FPN (e.g., by application of the updated NUC terms applied in block 571).

In block 572, a further high pass filter is applied with a larger kernel than was used in block 565, and further updated NUC terms may be determined in block 573. For example, to detect the spatially correlated FPN present in pixels 1110, the high pass filter applied in block 572 may include data from a sufficiently large enough neighborhood of pixels such that differences can be determined between unaffected pixels (e.g., pixels 1120) and affected pixels (e.g., pixels 1110). For example, a low pass filter with a large kernel can be used (e.g., an N by N kernel that is much greater than 3 by 3 pixels) and the results may be subtracted to perform appropriate high pass filtering.

In one embodiment, for computational efficiency, a sparse kernel may be used such that only a small number of neighboring pixels inside an N by N neighborhood are used. For any given high pass filter operation using distant neighbors (e.g., a large kernel), there is a risk of modeling actual (potentially blurred) scene information as spatially correlated FPN. Accordingly, in one embodiment, the temporal damping factor λ may be set close to 1 for updated NUC terms determined in block 573.

In various embodiments, blocks 571-573 may be repeated (e.g., cascaded) to iteratively perform high pass filtering with increasing kernel sizes to provide further updated NUC terms further correct for spatially correlated FPN of desired neighborhood sizes. In one embodiment, the decision to perform such iterations may be determined by whether spatially correlated FPN has actually been removed by the updated NUC terms of the previous performance of blocks 571-573.

After blocks 571-573 are finished, a decision is made regarding whether to apply the updated NUC terms to captured image frames (block 574). For example, if an average of the absolute value of the NUC terms for the entire image frame is less than a minimum threshold value, or greater than a maximum threshold value, the NUC terms may be deemed spurious or unlikely to provide meaningful correction. Alternatively, thresholding criteria may be applied to individual pixels to determine which pixels receive updated NUC terms. In one embodiment, the threshold values may correspond to differences between the newly calculated NUC terms and previously calculated NUC terms. In another embodiment, the threshold values may be independent of previously calculated NUC terms. Other tests may be applied (e.g., spatial correlation tests) to determine whether the NUC terms should be applied.

If the NUC terms are deemed spurious or unlikely to provide meaningful correction, then the flow diagram returns to block 505. Otherwise, the newly determined NUC terms are stored (block 575) to replace previous NUC terms (e.g., determined by a previously performed iteration of FIG. 5) and applied (block 580) to captured image frames.

FIG. 8 illustrates various image processing techniques of FIG. 5 and other operations applied in an image processing pipeline 800 in accordance with an embodiment of the disclosure. In this regard, pipeline 800 identifies various operations of FIG. 5 in the context of an overall iterative image processing scheme for correcting image frames provided by infrared imaging module 100. In some embodiments, pipeline 800 may be provided by processing module 160 or processor 195 (both also generally referred to as a processor) operating on image frames captured by infrared sensors 132.

Image frames captured by infrared sensors 132 may be provided to a frame averager 804 that integrates multiple image frames to provide image frames 802 with an improved signal to noise ratio. Frame averager 804 may be effectively provided by infrared sensors 132, ROIC 402, and other components of infrared sensor assembly 128 that are implemented to support high image capture rates. For example, in one embodiment, infrared sensor assembly 128 may capture infrared image frames at a frame rate of 240 Hz (e.g., 240 images per second). In this embodiment, such a high frame rate may be implemented, for example, by operating infrared sensor assembly 128 at relatively low voltages (e.g., compatible with mobile telephone voltages) and by using a relatively small array of infrared sensors 132 (e.g., an array of 64 by 64 infrared sensors in one embodiment).

In one embodiment, such infrared image frames may be provided from infrared sensor assembly 128 to processing module 160 at a high frame rate (e.g., 240 Hz or other frame rates). In another embodiment, infrared sensor assembly 128 may integrate over longer time periods, or multiple time periods, to provide integrated (e.g., averaged) infrared image frames to processing module 160 at a lower frame rate (e.g., 30 Hz, 9 Hz, or other frame rates). Further information regarding implementations that may be used to provide high image capture rates may be found in U.S. Provisional Patent Application No. 61/495,879 previously referenced herein.

Image frames 802 proceed through pipeline 800 where they are adjusted by various terms, temporally filtered, used to determine the various adjustment terms, and gain compensated.

In blocks 810 and 814, factory gain terms 812 and factory offset terms 816 are applied to image frames 802 to compensate for gain and offset differences, respectively, between the various infrared sensors 132 and/or other components of infrared imaging module 100 determined during manufacturing and testing.

In block 580, NUC terms 817 are applied to image frames 802 to correct for FPN as discussed. In one embodiment, if NUC terms 817 have not yet been determined (e.g., before a NUC process has been initiated), then block 580 may not be performed or initialization values may be used for NUC terms 817 that result in no alteration to the image data (e.g., offsets for every pixel would be equal to zero).

In blocks 818 and 822, column FPN terms 820 and row FPN terms 824, respectively, are applied to image frames 802. Column FPN terms 820 and row FPN terms 824 may be determined in accordance with block 550 as discussed. In one embodiment, if the column FPN terms 820 and row FPN terms 824 have not yet been determined (e.g., before a NUC process has been initiated), then blocks 818 and 822 may not be performed or initialization values may be used for the column FPN terms 820 and row FPN terms 824 that result in no alteration to the image data (e.g., offsets for every pixel would be equal to zero).

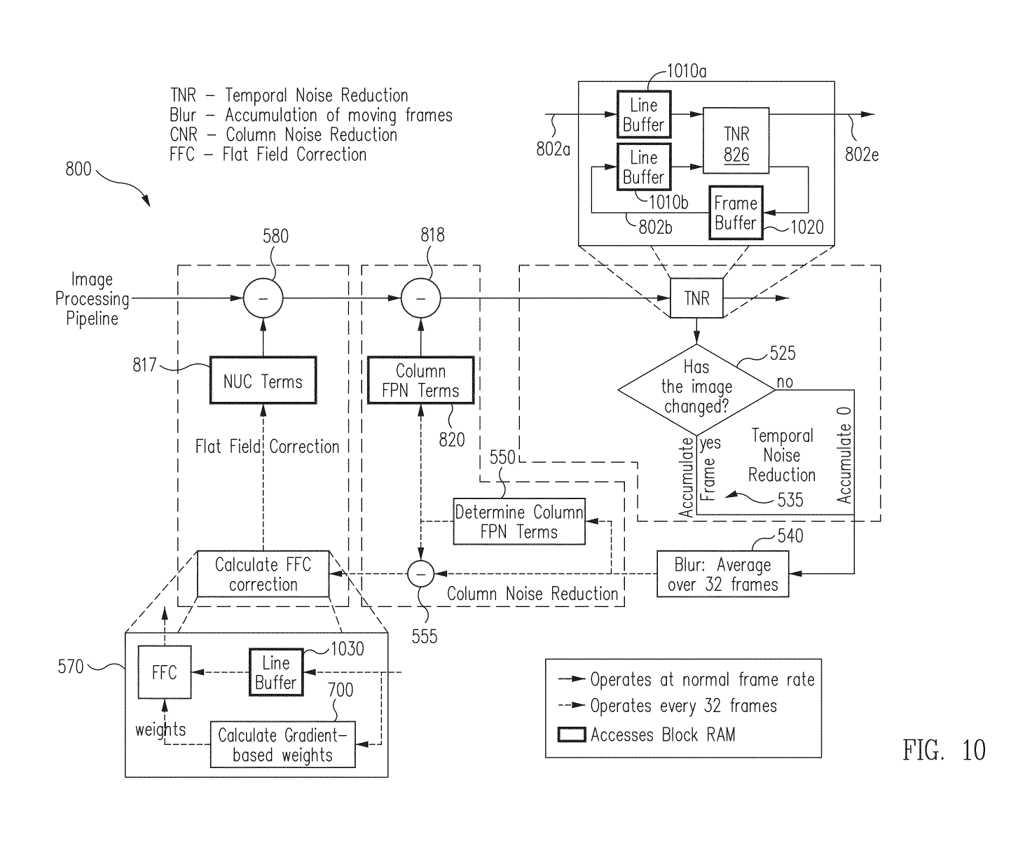

In block 826, temporal filtering is performed on image frames 802 in accordance with a temporal noise reduction (TNR) process. FIG. 9 illustrates a TNR process in accordance with an embodiment of the disclosure. In FIG. 9, a presently received image frame 802a and a previously temporally filtered image frame 802b are processed to determine a new temporally filtered image frame 802e. Image frames 802a and 802b include local neighborhoods of pixels 803a and 803b centered around pixels 805a and 805b, respectively. Neighborhoods 803a and 803b correspond to the same locations within image frames 802a and 802b and are subsets of the total pixels in image frames 802a and 802b. In the illustrated embodiment, neighborhoods 803a and 803b include areas of 5 by 5 pixels. Other neighborhood sizes may be used in other embodiments.

Differences between corresponding pixels of neighborhoods 803a and 803b are determined and averaged to provide an averaged delta value 805c for the location corresponding to pixels 805a and 805b. Averaged delta value 805c may be used to determine weight values in block 807 to be applied to pixels 805a and 805b of image frames 802a and 802b.

In one embodiment, as shown in graph 809, the weight values determined in block 807 may be inversely proportional to averaged delta value 805c such that weight values drop rapidly towards zero when there are large differences between neighborhoods 803a and 803b. In this regard, large differences between neighborhoods 803a and 803b may indicate that changes have occurred within the scene (e.g., due to motion) and pixels 802a and 802b may be appropriately weighted, in one embodiment, to avoid introducing blur across frame-to-frame scene changes. Other associations between weight values and averaged delta value 805c may be used in various embodiments.

The weight values determined in block 807 may be applied to pixels 805a and 805b to determine a value for corresponding pixel 805e of image frame 802e (block 811). In this regard, pixel 805e may have a value that is a weighted average (or other combination) of pixels 805a and 805b, depending on averaged delta value 805c and the weight values determined in block 807.

For example, pixel 805e of temporally filtered image frame 802e may be a weighted sum of pixels 805a and 805b of image frames 802a and 802b. If the average difference between pixels 805a and 805b is due to noise, then it may be expected that the average change between neighborhoods 805a and 805b will be close to zero (e.g., corresponding to the average of uncorrelated changes). Under such circumstances, it may be expected that the sum of the differences between neighborhoods 805a and 805b will be close to zero. In this case, pixel 805a of image frame 802a may both be appropriately weighted so as to contribute to the value of pixel 805e.

However, if the sum of such differences is not zero (e.g., even differing from zero by a small amount in one embodiment), then the changes may be interpreted as being attributed to motion instead of noise. Thus, motion may be detected based on the average change exhibited by neighborhoods 805a and 805b. Under these circumstances, pixel 805a of image frame 802a may be weighted heavily, while pixel 805b of image frame 802b may be weighted lightly.

Other embodiments are also contemplated. For example, although averaged delta value 805c has been described as being determined based on neighborhoods 805a and 805b, in other embodiments averaged delta value 805c may be determined based on any desired criteria (e.g., based on individual pixels or other types of groups of sets of pixels).

In the above embodiments, image frame 802a has been described as a presently received image frame and image frame 802b has been described as a previously temporally filtered image frame. In another embodiment, image frames 802a and 802b may be first and second image frames captured by infrared imaging module 100 that have not been temporally filtered.

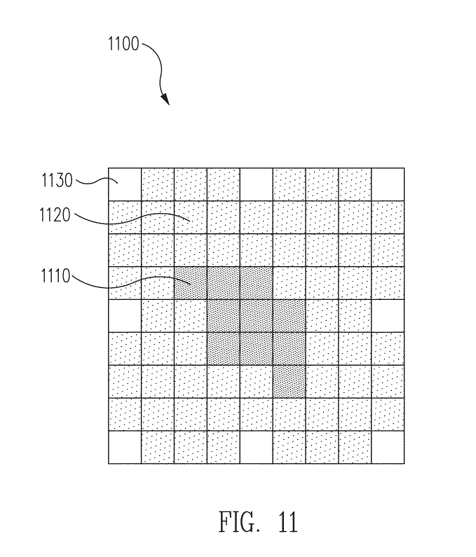

FIG. 10 illustrates further implementation details in relation to the TNR process of block 826. As shown in FIG. 10, image frames 802a and 802b may be read into line buffers 1010a and 1010b, respectively, and image frame 802b (e.g., the previous image frame) may be stored in a frame buffer 1020 before being read into line buffer 1010b. In one embodiment, line buffers 1010a-b and frame buffer 1020 may be implemented by a block of random access memory (RAM) provided by any appropriate component of infrared imaging module 100 and/or host device 102.

Referring again to FIG. 8, image frame 802e may be passed to an automatic gain compensation block 828 for further processing to provide a result image frame 830 that may be used by host device 102 as desired.

FIG. 8 further illustrates various operations that may be performed to determine row and column FPN terms and NUC terms as discussed. In one embodiment, these operations may use image frames 802e as shown in FIG. 8. Because image frames 802e have already been temporally filtered, at least some temporal noise may be removed and thus will not inadvertently affect the determination of row and column FPN terms 824 and 820 and NUC terms 817. In another embodiment, non-temporally filtered image frames 802 may be used.

In FIG. 8, blocks 510, 515, and 520 of FIG. 5 are collectively represented together. As discussed, a NUC process may be selectively initiated and performed in response to various NUC process initiating events and based on various criteria or conditions. As also discussed, the NUC process may be performed in accordance with a motion-based approach (blocks 525, 535, and 540) or a defocus-based approach (block 530) to provide a blurred image frame (block 545). FIG. 8 further illustrates various additional blocks 550, 552, 555, 560, 565, 570, 571, 572, 573, and 575 previously discussed with regard to FIG. 5.

As shown in FIG. 8, row and column FPN terms 824 and 820 and NUC terms 817 may be determined and applied in an iterative fashion such that updated terms are determined using image frames 802 to which previous terms have already been applied. As a result, the overall process of FIG. 8 may repeatedly update and apply such terms to continuously reduce the noise in image frames 830 to be used by host device 102.

Referring again to FIG. 10, further implementation details are illustrated for various blocks of FIGS. 5 and 8 in relation to pipeline 800. For example, blocks 525, 535, and 540 are shown as operating at the normal frame rate of image frames 802 received by pipeline 800. In the embodiment shown in FIG. 10, the determination made in block 525 is represented as a decision diamond used to determine whether a given image frame 802 has sufficiently changed such that it may be considered an image frame that will enhance the blur if added to other image frames and is therefore accumulated (block 535 is represented by an arrow in this embodiment) and averaged (block 540).

Also in FIG. 10, the determination of column FPN terms 820 (block 550) is shown as operating at an update rate that in this example is 1/32 of the sensor frame rate (e.g., normal frame rate) due to the averaging performed in block 540. Other update rates may be used in other embodiments. Although only column FPN terms 820 are identified in FIG. 10, row FPN terms 824 may be implemented in a similar fashion at the reduced frame rate.

FIG. 10 also illustrates further implementation details in relation to the NUC determination process of block 570. In this regard, the blurred image frame may be read to a line buffer 1030 (e.g., implemented by a block of RAM provided by any appropriate component of infrared imaging module 100 and/or host device 102). The flat field correction technique 700 of FIG. 7 may be performed on the blurred image frame.

In view of the present disclosure, it will be appreciated that techniques described herein may be used to remove various types of FPN (e.g., including very high amplitude FPN) such as spatially correlated row and column FPN and spatially uncorrelated FPN.

Other embodiments are also contemplated. For example, in one embodiment, the rate at which row and column FPN terms and/or NUC terms are updated can be inversely proportional to the estimated amount of blur in the blurred image frame and/or inversely proportional to the magnitude of local contrast values (e.g., determined in block 560).

In various embodiments, the described techniques may provide advantages over conventional shutter-based noise correction techniques. For example, by using a shutterless process, a shutter (e.g., such as shutter 105) need not be provided, thus permitting reductions in size, weight, cost, and mechanical complexity. Power and maximum voltage supplied to, or generated by, infrared imaging module 100 may also be reduced if a shutter does not need to be mechanically operated. Reliability will be improved by removing the shutter as a potential point of failure. A shutterless process also eliminates potential image interruption caused by the temporary blockage of the imaged scene by a shutter.

Also, by correcting for noise using intentionally blurred image frames captured from a real world scene (not a uniform scene provided by a shutter), noise correction may be performed on image frames that have irradiance levels similar to those of the actual scene desired to be imaged. This can improve the accuracy and effectiveness of noise correction terms determined in accordance with the various described techniques.

As discussed, in various embodiments, infrared imaging module 100 may be configured to operate at low voltage levels. In particular, infrared imaging module 100 may be implemented with circuitry configured to operate at low power and/or in accordance with other parameters that permit infrared imaging module 100 to be conveniently and effectively implemented in various types of host devices 102, such as mobile devices and other devices.

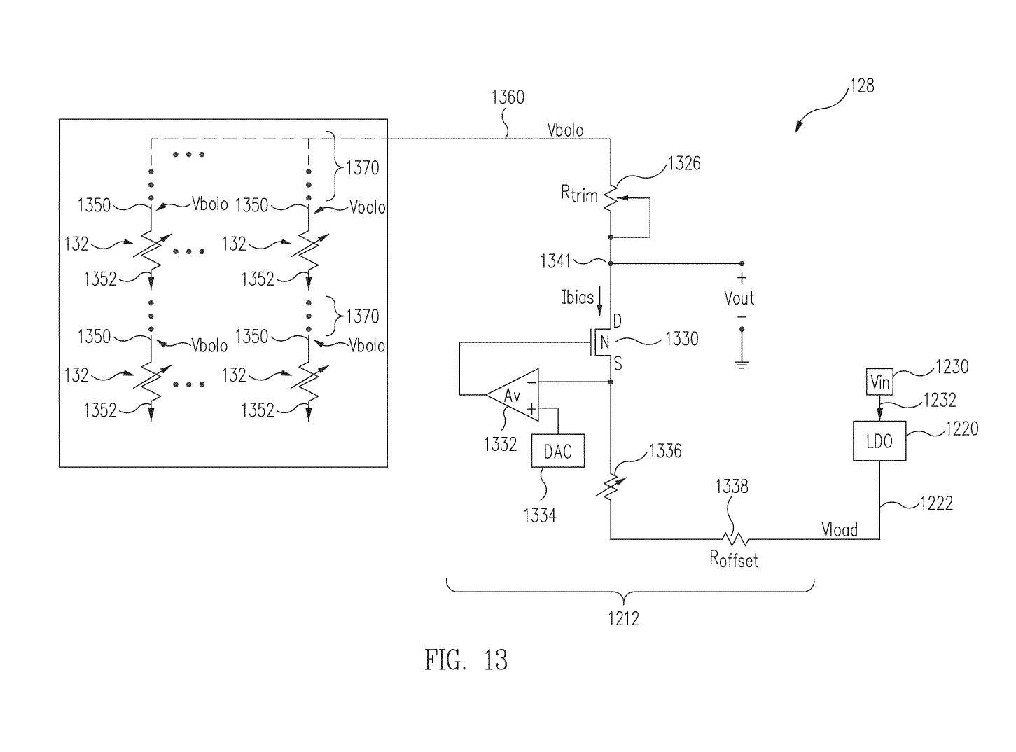

For example, FIG. 12 illustrates a block diagram of another implementation of infrared sensor assembly 128 including infrared sensors 132 and an LDO 1220 in accordance with an embodiment of the disclosure. As shown, FIG. 12 also illustrates various components 1202, 1204, 1205, 1206, 1208, and 1210 which may implemented in the same or similar manner as corresponding components previously described with regard to FIG. 4. FIG. 12 also illustrates bias correction circuitry 1212 which may be used to adjust one or more bias voltages provided to infrared sensors 132 (e.g., to compensate for temperature changes, self-heating, and/or other factors).

In some embodiments, LDO 1220 may be provided as part of infrared sensor assembly 128 (e.g., on the same chip and/or wafer level package as the ROIC). For example, LDO 1220 may be provided as part of an FPA with infrared sensor assembly 128. As discussed, such implementations may reduce power supply noise introduced to infrared sensor assembly 128 and thus provide an improved PSRR. In addition, by implementing the LDO with the ROIC, less die area may be consumed and fewer discrete die (or chips) are needed.

LDO 1220 receives an input voltage provided by a power source 1230 over a supply line 1232. LDO 1220 provides an output voltage to various components of infrared sensor assembly 128 over supply lines 1222. In this regard, LDO 1220 may provide substantially identical regulated output voltages to various components of infrared sensor assembly 128 in response to a single input voltage received from power source 1230.

For example, in some embodiments, power source 1230 may provide an input voltage in a range of approximately 2.8 volts to approximately 11 volts (e.g., approximately 2.8 volts in one embodiment), and LDO 1220 may provide an output voltage in a range of approximately 1.5 volts to approximately 2.8 volts (e.g., approximately 2.5 volts in one embodiment). In this regard, LDO 1220 may be used to provide a consistent regulated output voltage, regardless of whether power source 1230 is implemented with a conventional voltage range of approximately 9 volts to approximately 11 volts, or a low voltage such as approximately 2.8 volts. As such, although various voltage ranges are provided for the input and output voltages, it is contemplated that the output voltage of LDO 1220 will remain fixed despite changes in the input voltage.

The implementation of LDO 1220 as part of infrared sensor assembly 128 provides various advantages over conventional power implementations for FPAs. For example, conventional FPAs typically rely on multiple power sources, each of which may be provided separately to the FPA, and separately distributed to the various components of the FPA. By regulating a single power source 1230 by LDO 1220, appropriate voltages may be separately provided (e.g., to reduce possible noise) to all components of infrared sensor assembly 128 with reduced complexity. The use of LDO 1220 also allows infrared sensor assembly 128 to operate in a consistent manner, even if the input voltage from power source 1230 changes (e.g., if the input voltage increases or decreases as a result of charging or discharging a battery or other type of device used for power source 1230).

The various components of infrared sensor assembly 128 shown in FIG. 12 may also be implemented to operate at lower voltages than conventional devices. For example, as discussed, LDO 1220 may be implemented to provide a low voltage (e.g., approximately 2.5 volts). This contrasts with the multiple higher voltages typically used to power conventional FPAs, such as: approximately 3.3 volts to approximately 5 volts used to power digital circuitry; approximately 3.3 volts used to power analog circuitry; and approximately 9 volts to approximately 11 volts used to power loads. Also, in some embodiments, the use of LDO 1220 may reduce or eliminate the need for a separate negative reference voltage to be provided to infrared sensor assembly 128.

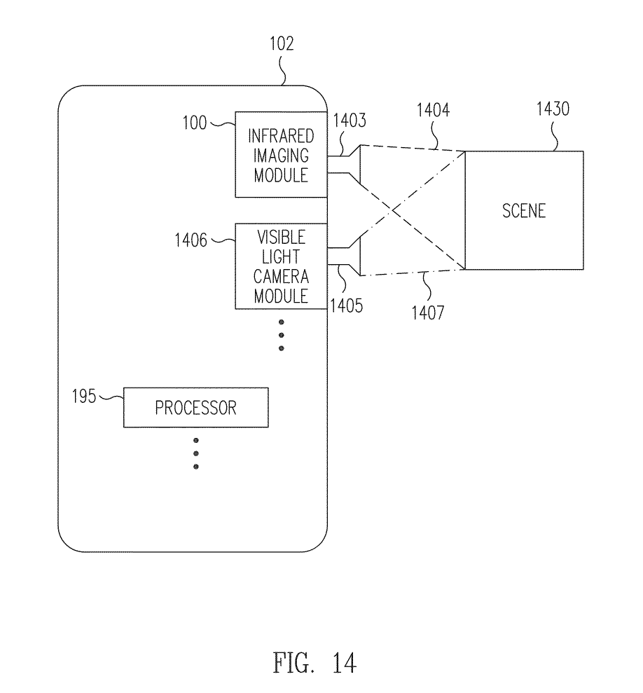

Additional aspects of the low voltage operation of infrared sensor assembly 128 may be further understood with reference to FIG. 13. FIG. 13 illustrates a circuit diagram of a portion of infrared sensor assembly 128 of FIG. 12 in accordance with an embodiment of the disclosure. In particular, FIG. 13 illustrates additional components of bias correction circuitry 1212 (e.g., components 1326, 1330, 1332, 1334, 1336, 1338, and 1341) connected to LDO 1220 and infrared sensors 132. For example, bias correction circuitry 1212 may be used to compensate for temperature-dependent changes in bias voltages in accordance with an embodiment of the present disclosure. The operation of such additional components may be further understood with reference to similar components identified in U.S. Pat. No. 7,679,048 issued Mar. 16, 2010 which is hereby incorporated by reference in its entirety. Infrared sensor assembly 128 may also be implemented in accordance with the various components identified in U.S. Pat. No. 6,812,465 issued Nov. 2, 2004 which is hereby incorporated by reference in its entirety.

In various embodiments, some or all of the bias correction circuitry 1212 may be implemented on a global array basis as shown in FIG. 13 (e.g., used for all infrared sensors 132 collectively in an array). In other embodiments, some or all of the bias correction circuitry 1212 may be implemented an individual sensor basis (e.g., entirely or partially duplicated for each infrared sensor 132). In some embodiments, bias correction circuitry 1212 and other components of FIG. 13 may be implemented as part of ROIC 1202.

As shown in FIG. 13, LDO 1220 provides a load voltage Vload to bias correction circuitry 1212 along one of supply lines 1222. As discussed, in some embodiments, Vload may be approximately 2.5 volts which contrasts with larger voltages of approximately 9 volts to approximately 11 volts that may be used as load voltages in conventional infrared imaging devices.

Based on Vload, bias correction circuitry 1212 provides a sensor bias voltage Vbolo at a node 1360. Vbolo may be distributed to one or more infrared sensors 132 through appropriate switching circuitry 1370 (e.g., represented by broken lines in FIG. 13). In some examples, switching circuitry 1370 may be implemented in accordance with appropriate components identified in U.S. Pat. Nos. 6,812,465 and 7,679,048 previously referenced herein.

Each infrared sensor 132 includes a node 1350 which receives Vbolo through switching circuitry 1370, and another node 1352 which may be connected to ground, a substrate, and/or a negative reference voltage. In some embodiments, the voltage at node 1360 may be substantially the same as Vbolo provided at nodes 1350. In other embodiments, the voltage at node 1360 may be adjusted to compensate for possible voltage drops associated with switching circuitry 1370 and/or other factors.

Vbolo may be implemented with lower voltages than are typically used for conventional infrared sensor biasing. In one embodiment, Vbolo may be in a range of approximately 0.2 volts to approximately 0.7 volts. In another embodiment, Vbolo may be in a range of approximately 0.4 volts to approximately 0.6 volts. In another embodiment, Vbolo may be approximately 0.5 volts. In contrast, conventional infrared sensors typically use bias voltages of approximately 1 volt.

The use of a lower bias voltage for infrared sensors 132 in accordance with the present disclosure permits infrared sensor assembly 128 to exhibit significantly reduced power consumption in comparison with conventional infrared imaging devices. In particular, the power consumption of each infrared sensor 132 is reduced by the square of the bias voltage. As a result, a reduction from, for example, 1.0 volt to 0.5 volts provides a significant reduction in power, especially when applied to many infrared sensors 132 in an infrared sensor array. This reduction in power may also result in reduced self-heating of infrared sensor assembly 128.

In accordance with additional embodiments of the present disclosure, various techniques are provided for reducing the effects of noise in image frames provided by infrared imaging devices operating at low voltages. In this regard, when infrared sensor assembly 128 is operated with low voltages as described, noise, self-heating, and/or other phenomena may, if uncorrected, become more pronounced in image frames provided by infrared sensor assembly 128.

For example, referring to FIG. 13, when LDO 1220 maintains Vload at a low voltage in the manner described herein, Vbolo will also be maintained at its corresponding low voltage and the relative size of its output signals may be reduced. As a result, noise, self-heating, and/or other phenomena may have a greater effect on the smaller output signals read out from infrared sensors 132, resulting in variations (e.g., errors) in the output signals. If uncorrected, these variations may be exhibited as noise in the image frames. Moreover, although low voltage operation may reduce the overall amount of certain phenomena (e.g., self-heating), the smaller output signals may permit the remaining error sources (e.g., residual self-heating) to have a disproportionate effect on the output signals during low voltage operation.

To compensate for such phenomena, infrared sensor assembly 128, infrared imaging module 100, and/or host device 102 may be implemented with various array sizes, frame rates, and/or frame averaging techniques. For example, as discussed, a variety of different array sizes are contemplated for infrared sensors 132. In some embodiments, infrared sensors 132 may be implemented with array sizes ranging from 32 by 32 to 160 by 120 infrared sensors 132. Other example array sizes include 80 by 64, 80 by 60, 64 by 64, and 64 by 32. Any desired array size may be used.

Advantageously, when implemented with such relatively small array sizes, infrared sensor assembly 128 may provide image frames at relatively high frame rates without requiring significant changes to ROIC and related circuitry. For example, in some embodiments, frame rates may range from approximately 120 Hz to approximately 480 Hz.

In some embodiments, the array size and the frame rate may be scaled relative to each other (e.g., in an inversely proportional manner or otherwise) such that larger arrays are implemented with lower frame rates, and smaller arrays are implemented with higher frame rates. For example, in one embodiment, an array of 160 by 120 may provide a frame rate of approximately 120 Hz. In another embodiment, an array of 80 by 60 may provide a correspondingly higher frame rate of approximately 240 Hz. Other frame rates are also contemplated.

By scaling the array size and the frame rate relative to each other, the particular readout timing of rows and/or columns of the FPA may remain consistent, regardless of the actual FPA size or frame rate. In one embodiment, the readout timing may be approximately 63 microseconds per row or column.

As previously discussed with regard to FIG. 8, the image frames captured by infrared sensors 132 may be provided to a frame averager 804 that integrates multiple image frames to provide image frames 802 (e.g., processed image frames) with a lower frame rate (e.g., approximately 30 Hz, approximately 60 Hz, or other frame rates) and with an improved signal to noise ratio. In particular, by averaging the high frame rate image frames provided by a relatively small FPA, image noise attributable to low voltage operation may be effectively averaged out and/or substantially reduced in image frames 802. Accordingly, infrared sensor assembly 128 may be operated at relatively low voltages provided by LDO 1220 as discussed without experiencing additional noise and related side effects in the resulting image frames 802 after processing by frame averager 804.

Other embodiments are also contemplated. For example, although a single array of infrared sensors 132 is illustrated, it is contemplated that multiple such arrays may be used together to provide higher resolution image frames (e.g., a scene may be imaged across multiple such arrays). Such arrays may be provided in multiple infrared sensor assemblies 128 and/or provided in the same infrared sensor assembly 128. Each such array may be operated at low voltages as described, and also may be provided with associated ROIC circuitry such that each array may still be operated at a relatively high frame rate. The high frame rate image frames provided by such arrays may be averaged by shared or dedicated frame averagers 804 to reduce and/or eliminate noise associated with low voltage operation. As a result, high resolution infrared images may be obtained while still operating at low voltages.

In various embodiments, infrared sensor assembly 128 may be implemented with appropriate dimensions to permit infrared imaging module 100 to be used with a small form factor socket 104, such as a socket used for mobile devices. For example, in some embodiments, infrared sensor assembly 128 may be implemented with a chip size in a range of approximately 4.0 mm by approximately 4.0 mm to approximately 5.5 mm by approximately 5.5 mm (e.g., approximately 4.0 mm by approximately 5.5 mm in one example). Infrared sensor assembly 128 may be implemented with such sizes or other appropriate sizes to permit use with socket 104 implemented with various sizes such as: 8.5 mm by 8.5 mm, 8.5 mm by 5.9 mm, 6.0 mm by 6.0 mm, 5.5 mm by 5.5 mm, 4.5 mm by 4.5 mm, and/or other socket sizes such as, for example, those identified in Table 1 of U.S. Provisional Patent Application No. 61/495,873 previously referenced herein.

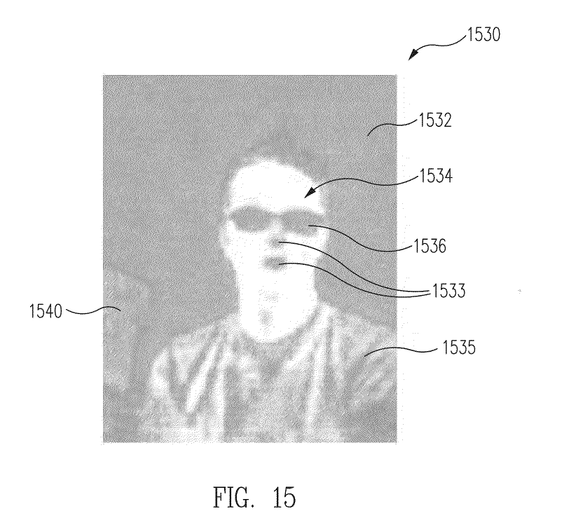

Referring now to FIG. 14, a block diagram is shown of another implementation of host system 102 showing how system 102 may include one or more non-thermal imaging modules such as visible light camera module 1406 in addition to one or more infrared imaging modules such as infrared imaging module 100 in accordance with an embodiment of the disclosure. System 102 may be used to monitor a real-world scene such as scene 1430.

System 102 may include one or more infrared imaging modules 100, one or more visible light cameras 1406, and additional components as described above in connection with FIG. 1 (e.g., processor 195, memory 196, display 197, one or more motion sensors 194, and/or other components 198 such as a control panel, alert components, or communications components). In various embodiments, components of system 102 of FIG. 14 may be implemented in the same or similar manner as corresponding components of host device 102 of FIG. 1. Moreover, components of system 102 may be configured to perform various NUC processes and other processes described herein.

As shown in FIG. 14, in some embodiments, infrared imaging module 100 may include various optical elements 1403 (e.g., one or more infrared-transmissive lenses, one or more infrared-transmissive prisms, one or more infrared-reflective mirrors, or one or more infrared fiber optic elements) that guide infrared radiation from scene 1430 to an FPA of infrared imaging module 100. In some embodiments, optical elements 1403 may be used to suitably define or alter FOV 1404 of infrared imaging module 100. A switchable FOV (e.g., selectable by infrared imaging module 100 and/or processor 195) may optionally be provided, which may be useful when, for example, a selective close-up view of a portion of scene 1430 is desired.

Optical elements 1403 may also include one or more filters adapted to pass infrared radiation of some wavelengths but substantially block infrared radiation of other wavelengths (e.g., short-wave infrared (SWIR) filters, mid-wave infrared (MWIR) filters, long-wave infrared (LWIR) filters, and narrow-band filters). Such filters may be utilized to tailor infrared imaging module 100 for increased sensitivity to a desired band of infrared wavelengths. For example, in some situations, it may be desirable to detect exhaled breaths of a person or an animal. In this type of situation, a better result may be achieved by utilizing a narrow-band filter that transmits only in the wavelengths matching a specific absorption/emission spectrum of carbon dioxide (CO₂) or other constituent gases of an exhaled breath. In other situations it may be desirable to detect the presence of toxic gases or other dangerous chemicals by utilizing a narrow-band filter that transmits only in the wavelengths matching a specific absorption/emission spectrum of the gasses or chemicals. In some embodiments, filters may be selectable (e.g., provided as a selectable filter wheel). In other embodiments, filters may be fixed as appropriate for a desired application of system 102.

Visible light camera 1406 may be a small form factor non-thermal imaging module or imaging device, and may be implemented in a similar manner as various embodiments of infrared imaging module 100 disclosed herein, but with one or more sensors responsive to non-thermal radiation (e.g., radiation in the visible, near infrared, short-wave infrared or other non-thermal portion of the electromagnetic spectrum). For example, in some embodiments, visible light camera 1406 may be implemented with a charge-coupled device (CCD) sensor, an electron multiplying CCD (EMCCD) sensor, a complementary metal-oxide-semiconductor (CMOS) sensor, a scientific CMOS (sCMOS) sensor, an intensified charge-coupled device (ICCD), or other sensors.

As shown in FIG. 14, in some embodiments, visible light camera module 1406 may include various optical elements 1405 (e.g., one or more lenses, one or more color filters, one or more prisms, one or more mirrors, or one or more fiber optic elements) that guide non-thermal radiation from scene 1430 to visible light camera module 1406. In some embodiments, optical elements 1405 may be used to suitably define or alter FOV 1407 of visible light camera module 1406. A switchable FOV (e.g., selectable by visible light camera module 1406 and/or processor 195) may optionally be provided, which may be useful when, for example, a selective close-up view of a portion of scene 1430 is desired. If desired, elements 1403 and 1405 may be operable to alternately switch between an infrared imaging mode and a visible light imaging mode for system 102.

Optical elements 1405 may also include one or more filters adapted to pass radiation of some wavelengths (colors) but substantially block radiation of other wavelengths (e.g., red color filters, blue color filters, green color filters, near-infrared color filters, short-wave infrared filters, and narrow-band filters). In some embodiments, filters of elements 1405 may be selectable (e.g., provided as a selectable filter wheel). In other embodiments, filters of element 1405 may be fixed as appropriate for a desired application of system 102. Although camera module 1406 is sometimes referred to herein as a visible light camera module as an example, it should be appreciated that camera module 1406 may be any suitable non-thermal camera module as described herein that generates images in response to incoming light having any suitable corresponding range of non-thermal wavelengths (e.g., visible light wavelengths, near infrared wavelengths, short-wave infrared wavelengths or other wavelengths that are relatively shorter than thermal infrared wavelengths).

In some embodiments, non-thermal images such as visible light images captured by visible light camera 1406 may be received by processor 195, which may be configured to fuse, superimpose, or otherwise combine the visible light images with the thermal images captured by infrared imaging module 100 as further described herein.

In some embodiments, visible light camera 1406 may be co-located with infrared imaging module 100 in a packaging structure and oriented so that FOV 1407 of visible light camera 1406 at least partially overlaps FOV 1404 of infrared imaging module 100. In one example, infrared imaging module 100 and visible light camera 1406 may be implemented as a dual sensor module sharing a common substrate according to various techniques described in U.S. Provisional Patent Application No. 61/748,018 previously referenced herein. Such a dual sensor module implementation may include common circuitry and/or common restraint devices for infrared imaging and visible light imaging, thereby potentially reducing an overall size of system 102 as compared to embodiments where infrared imaging module 100 and visible light camera 1406 are implemented as individual modules. Additionally, the dual sensor module implementation may be adapted to reduce a parallax error between images captured by infrared imaging module 100 and visible light camera 1406 by reducing the distance between them.

Infrared images captured, processed, and/or otherwise managed by infrared imaging module 100 may be radiometrically normalized infrared images (e.g., thermal images). That is, pixels that make up the captured image may contain calibrated thermal data (e.g., temperature data). As discussed above in connection with FIG. 1, infrared imaging module 100 and/or associated components may be calibrated using appropriate techniques so that images captured by infrared imaging module 100 are properly calibrated thermal images. In some embodiments, appropriate calibration processes may be performed periodically by infrared imaging module 100 and/or processor 195 so that infrared imaging module 100, and hence the thermal images captured by it, may maintain proper calibration.

Radiometric normalization permits infrared imaging module 100 and/or processor 195 to efficiently detect, from thermal images, objects having a specific range of temperature. Infrared imaging module 100 and/or processor 195 may detect such objects efficiently and effectively, because thermal images of objects having a specific temperature may be easily discernible from a background and other objects, and yet less susceptible to lighting conditions or obscuring (e.g., obscured by clothing).

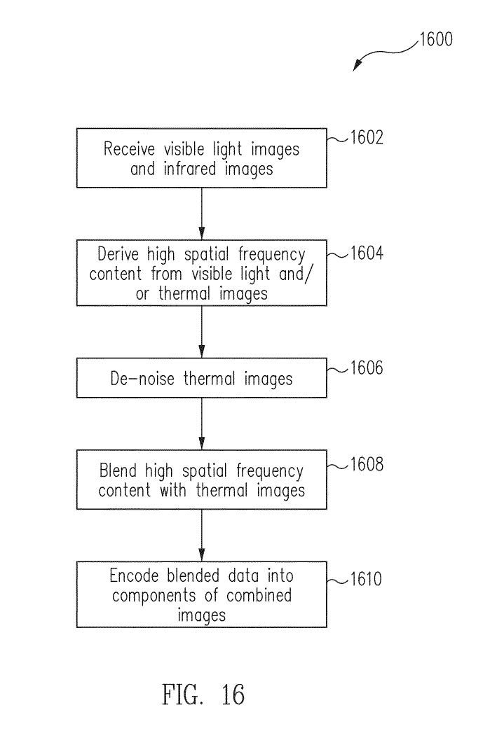

Also referring to FIG. 15, an example thermal image 1530 (shown as a user-viewable thermal image for ease of understanding, with lighter portions representing higher temperatures) that may be captured by infrared imaging module 100 is shown. As this example thermal image shows, a human such as person 1534 generally exhibits a higher temperature than a background such as background 1532. Furthermore, facial features 1533 such as a mouth and nostrils, glasses 1536, clothed portion 1535, and object 1540 (e.g., an object held in the person's hand) generally exhibit various temperatures that can be differentiated in a thermal image such as thermal image 1530. Thus, various features of a person such as person 1534 that is detected in a thermal image such as image 1530 may be accurately and yet efficiently differentiated and tracked using appropriate detection and tracking operations described herein and elsewhere.

In some embodiments, if visible light images captured by visible light camera 1406 are available, processor 195 may be configured to track features of a scene such as multiple individual people or even the face and facial features of an individual person based additionally or alternatively on the visible light images. For example, the visible light images may provide more detail and contrast than the thermal images in certain ambient light conditions, and thus may be analyzed using suitable face tracking algorithms in such favorable light conditions. In another example, both the visible light images and the thermal images may be analyzed to complementarily increase detection and tracking accuracy. In another example, the thermal images and the visible light images may be combined or fused as further described herein, and the combined or fused images may be analyzed to track the features of the scene. If processor 195 is configured to detect and track the features of a scene using the visible light images, processor 195 may be further configured to convert pixel coordinates of the tracked features in the visible light images to corresponding pixel coordinates in the thermal images.

In some embodiments, thermal images from one or more infrared imaging modules such as infrared imaging module 100 and non-thermal images from one or more non-thermal camera modules such as visible light camera module 1406 may be fused or combined to generate images having a higher definition, contrast, and/or detail.

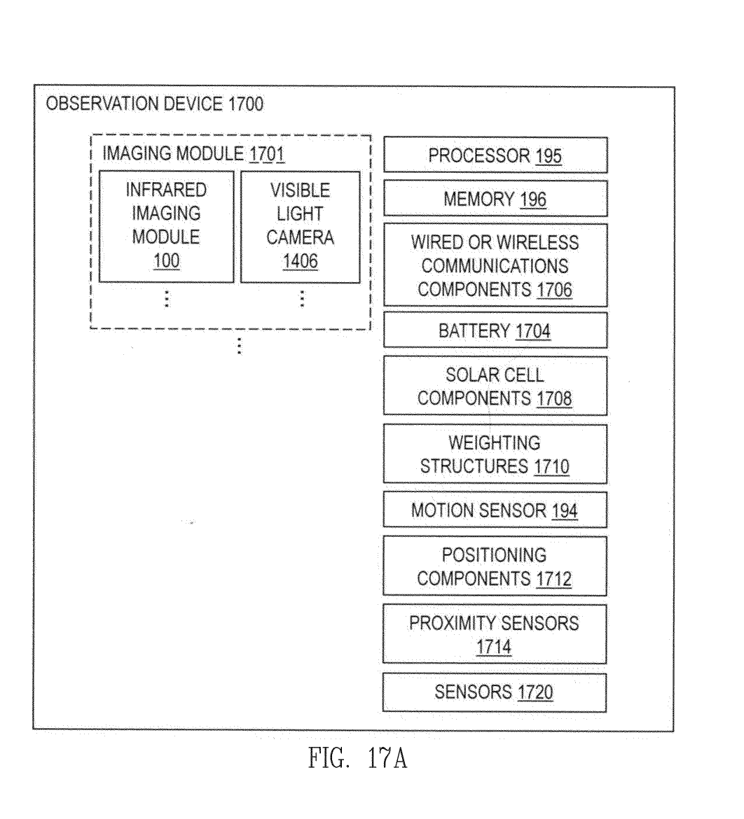

The fusing or combining operations in accordance with one or more embodiments may be described in further detail with reference to FIG. 16, which is a flowchart of a process 1600 to combine or fuse the thermal images and the non-thermal (e.g., visible light) images. The combined images may include radiometric data and/or other infrared characteristics corresponding to scene 1430, but with significantly more object detail (e.g., contour or edge detail) and/or contrast than typically provided by the thermal or non-thermal images alone. Thus, for example, the combined images generated in these examples may beneficially provide sufficient radiometric data, detail, and contrast to allow easier recognition and/or interpretation of the presence, location, position, or other features of objects such as humans or animals in scene 1430.

Although the process described herein in connection with FIG. 16 discusses fusing or combining thermal images with visible light images as an example, it should be appreciated that the process may be applied to combining thermal images with any suitable non-thermal images (e.g., visible light images, near infrared images, short-wave infrared images, EMCCD images, ICCD images, or other non-thermal images).

At block 1602, visible light images and infrared images such as thermal images may be received. For example, visible light images of scene 1430 may be captured by visible light camera 1406 and the captured visible light images may be received by processor 195. Processor 195 may perform various operations of process 1600 using both thermal images and non-thermal images, for example.

At block 1604, high spatial frequency content from one or more of the visible light and thermal images may be derived from one or more of the visible light and thermal images received in block 1602. High spatial frequency content derived according to various embodiments may include edge/contour details and/or high contrast pixels extracted from the one or more of the visible light and thermal images, for example.

In one embodiment, high spatial frequency content may be derived from the received images by performing a high pass filter (e.g., a spatial filter) operation on the images, where the result of the high pass filter operation is the high spatial frequency content. In an alternative embodiment, high spatial frequency content may be derived from the received images by performing a low pass filter operation on the images, and then subtracting the result from the original images to get the remaining content, which is the high spatial frequency content. In another embodiment, high spatial frequency content may be derived from a selection of images through difference imaging, for example, where one image is subtracted from a second image that is perturbed from the first image in some fashion, and the result of the subtraction is the high spatial frequency content. For example, optical elements 1403 of infrared imaging module 100 and/or optical elements 1405 of visible light camera 1406 may be configured to introduce vibration, de-focusing, and/or movement artifacts into a series of images captured by one or both of infrared imaging module 100 and visible light camera 1406. High spatial frequency content may be derived from subtractions of images such as adjacent images in the series.

In some embodiments, high spatial frequency content may be derived from only the visible light images or the thermal images. In other embodiments, high spatial frequency content may be derived from only a single visible light or thermal image. In further embodiments, high spatial frequency content may be derived from one or more components of the visible light and/or thermal mages, such as a luminance component of visible light images, for example, or a radiometric component of thermal images. Resulting high spatial frequency content may be stored temporarily (e.g., in memory 196) and/or may be further processed according to block 1608.

At block 1606, one or more thermal images may be de-noised. For example, processor 195 may be configured to de-noise, smooth, or blur one or more thermal images of scene 1430 using a variety of image processing operations. In one embodiment, removing high spatial frequency noise from the thermal images allows the processed thermal images to be combined with high spatial frequency content derived according to block 1604 with significantly less risk of introducing double edges (e.g., edge noise) to objects depicted in combined images of scene 1430.

In one embodiment, removing noise from the thermal mages may include performing a low pass filter (e.g., a spatial and/or temporal filter) operation on the images, where the result of the low pass filter operation is de-noised or processed thermal images. In a further embodiment, removing noise from one or more thermal images may include down-sampling the thermal images and then up-sampling the images back to the original resolution.

In another embodiment, processed thermal images may be derived by actively blurring thermal images of scene 1430. For example, optical elements 1403 may be configured to slightly de-focus one or more thermal images captured by infrared imaging module 100. The resulting intentionally blurred thermal images may be sufficiently de-noised or blurred so as to reduce or eliminate a risk of introducing double edges into combined images of scene 1430, as further described below. In other embodiments, blurring or smoothing image processing operations may be performed by processor 195 on the received thermal images as an alternative or supplement to using optical elements 1403 to actively blur thermal images of scene 1430. Resulting processed thermal images may be stored temporarily (e.g., in memory 196) and/or may be further processed according to block 1608.

At block 1608, high spatial frequency content may be blended with one or more thermal images. For example, processor 195 may be configured to blend high spatial frequency content derived in block 1604 with one or more thermal images of scene 1430, such as the processed thermal images provided in block 1606.

In one embodiment, high spatial frequency content may be blended with thermal images by superimposing the high spatial frequency content onto the thermal images, where the high spatial frequency content replaces or overwrites those portions of the thermal images corresponding to where the high spatial frequency content exists. For example, the high spatial frequency content may include edges of objects depicted in images of scene 1430, but may not exist within the interior of such objects. In such embodiments, blended image data may simply include the high spatial frequency content, which may subsequently be encoded into one or more components of combined images, as described in block 1610.

For example, a radiometric component of thermal images may be a chrominance component of the thermal images, and the high spatial frequency content may be derived from the luminance and/or chrominance components of visible light images. In this embodiment, combined images may include the radiometric component (e.g., the chrominance component of the thermal images) encoded into a chrominance component of the combined images and the high spatial frequency content directly encoded (e.g., as blended image data but with no thermal image contribution) into a luminance component of the combined images. By doing so, a radiometric calibration of the radiometric component of the thermal images may be retained. In similar embodiments, blended image data may include the high spatial frequency content added to a luminance component of the thermal images, and the resulting blended data encoded into a luminance component of resulting combined images.

In other embodiments, high spatial frequency content may be derived from one or more particular components of one or a series of visible light and/or thermal images, and the high spatial frequency content may be encoded into corresponding one or more components of combined images. For example, the high spatial frequency content may be derived from a luminance component of visible spectrum images, and the high spatial frequency content, which in this embodiment is all luminance image data, may be encoded into a luminance component of combined images.

In another embodiment, high spatial frequency content may be blended with thermal images using a blending parameter and an arithmetic equation. For example, in one embodiment, the high spatial frequency content may be derived from a luminance component of visible light images. In such an embodiment, the high spatial frequency content may be blended with a corresponding luminance component of thermal image according to a blending parameter and a blending equation to produce blended image data. The blended image data may be encoded into a luminance component of combined images, for example, and the chrominance component of the thermal images may be encoded into the chrominance component of the combined images. In embodiments where the radiometric component of the infrared images may be their chrominance component, the combined images may retain a radiometric calibration of the thermal images. In other embodiments, portions of the radiometric component may be blended with the high spatial frequency content and then encoded into combined images.

More generally, the high spatial frequency content may be derived from one or more components of visible light images and/or thermal image. In such an embodiment, the high spatial frequency content may be blended with one or more components of the thermal images to produce blended image data (e.g., using a blending parameter and a blending equation), and resulting combined images may include the blended image data encoded into corresponding one or more components of the combined images. In some embodiments, the one or more components of the blended data do not have to correspond to the eventual one or more components of the combined images (e.g., a color space/format conversion may be performed as part of an encoding process).

A blending parameter value may be selected by a user or may be automatically determined by processor 195 according to context or other data, for example, or according to an image enhancement level expected by system 102. In some embodiments, the blending parameter may be adjusted or refined while combined images are being displayed (e.g., by display 197). In some embodiments, a blending parameter may be selected such that blended image data includes only thermal characteristics, or, alternatively, only visible light characteristics. A blending parameter may also be limited in range, for example, so as not to produce blended data that is out-of-bounds with respect to a dynamic range of a particular color space/format or a display.

In addition to or as an alternative to the processing described above, processing according to the high contrast mode may include one or more processing steps, ordering of processing steps, arithmetic combinations, and/or adjustments to blending parameters as disclosed in U.S. patent application Ser. No. 13/437,645 previously referenced herein. For example, the following equations may be used to determine the components Y, Cr and Cb for the combined images with the Y component from the high pass filtered visible light images and the Cr and Cb components from the thermal images.

hp_y_vis=highpass(y_vis)

(y_ir,cr_ir,cb_ir)=colored(lowpass(ir_signal_linear))

In the above equations, highpass(y_vis) may be high spatial frequency content derived from high pass filtering a luminance component of visible light images. Colored(lowpass(ir_signal_linear)) may be the resulting luminance and chrominance components of the thermal images after the thermal images are low pass filtered. In some embodiments, the thermal images may include a luminance component that is selected to be 0.5 times a maximum luminance (e.g., of a display and/or a processing step). In related embodiments, the radiometric component of the thermal images may be the chrominance component of the thermal images. In some embodiments, the y_ir component of the thermal images may be dropped and the components of the combined images may be (hp_y_vis, or_ir, cb_ir), using the notation above.

In another embodiment, the following equations may be used to determine the components Y, Cr and Cb for combined images with the Y component from the high pass filtered visible light images and the Cr and Cb components from the thermal images.

comb_y=y_ir+alpha×hp_y_vis

comb_cr=cr_ir

comb_cb=cb_ir

The variation of alpha thus gives the user an opportunity to decide how much contrast is needed in the combined images. With an alpha of close to zero, the thermal images alone will be shown, but with a very high alpha, very sharp contours/edges can be seen in the combined images. Theoretically, alpha can be an infinitely large number, but in practice a limitation will probably be necessary, to limit the size of alpha that can be chosen to what will be convenient in the current application.

Once the high spatial frequency content is blended with one or more thermal images, processing may proceed to block 1610, where blended data may be encoded into components of the combined images in order to form the combined images.

At block 1610, the blended data may be encoded into one or more components of the combined images. For example, processor 195 may be configured to encode blended data derived or produced in accordance with block 1608 into combined images that increases, refines, or otherwise enhances the information conveyed by either the visible light or thermal images viewed by themselves. In some embodiments, encoding blended image data into a component of combined images may include additional image processing operations, for example, such as dynamic range adjustment, normalization, gain and offset operations, noise reduction, and color space conversions, for instance.

In addition, processor 195 may be configured to encode other image data into combined images. For example, if blended image data is encoded into a luminance component of combined images, a chrominance component of either visible light images or thermal images may be encoded into a chrominance component of combined images. Selection of source images may be made through user input, for example, or may be determined automatically based on context or other data. More generally, in some embodiments, a component of combined images that is not encoded with blended data may be encoded with a corresponding component of visible light images or thermal images. By doing so, a radiometric calibration of thermal images and/or a color space calibration of visible light images may be retained in the resulting combined images.

In some embodiments, at least some part or some functionalities of processor 195 described herein may be implemented as part of infrared imaging modules 100, for example, at processing module 160 described above in connection with FIG. 3. In some embodiments, at least some part or some functionalities of processor 195 may be part of or implemented with other existing processors of an external device such as a mobile phone, a tablet device, a laptop computer, a desktop computer, an automobile information display system, or any other devices that may be used to present monitoring information from a monitoring system. In other embodiments, processor 195 may interface and communicate with such other external processors and components associated with such processors.

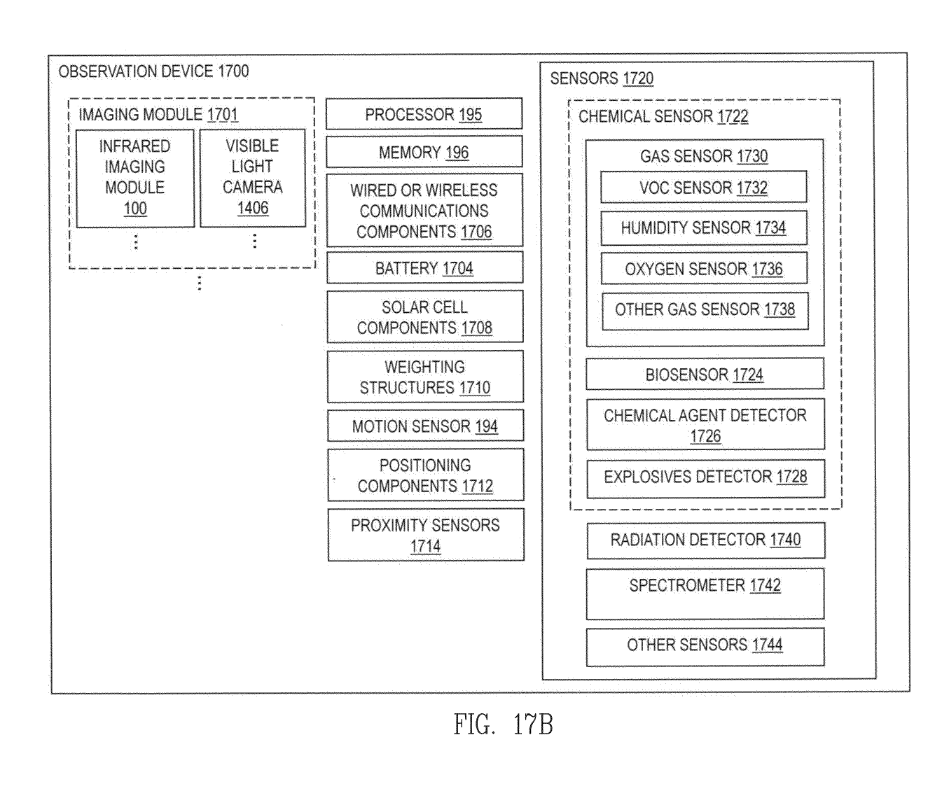

In one suitable configuration that is sometimes discussed herein as an example, system 102 may be implemented as a durable compact multisensor observation device such as observation device 1700 of FIG. 17A. As shown in FIG. 17A, durable compact multisensor observation device 1700 may include one or more imaging modules such as imaging module 1701. Observation device 1700 may be a throwable imaging device such as a throwable thermal imaging device that can be projected into a potentially hostile environment by a human thrower or other launching device.

Imaging module 1701 may include one or more infrared imaging modules 100 and/or one or more visible light cameras 1406. In one suitable configuration that is sometimes discussed herein as an example, each imaging module 1701 includes an infrared imaging module 100 configured to capture thermal images and a visible light camera 1406 configured to capture images in response to one or more colors of visible light. However, this is merely illustrative. If desired, imaging module 1701 may include any number of infrared imaging modules that are sensitive to any suitable range of infrared wavelengths and/or any number of visible light cameras that are sensitive to any suitable range of visible or even near infrared light. Infrared imaging modules 100 and visible light camera modules 1406 may be implemented in various suitable configurations in imaging module 1701 as described above in connection with FIG. 14 (e.g., infrared imaging modules 100 and visible light camera modules 1406 may be formed on a common substrate, formed on separate substrates, may have overlapping and/or switchable fields of view, etc.).

As shown in FIG. 17A, imaging modules 1701 may be formed within a housing structure such as housing 1702. Housing 1702 may be a durable housing structure that is configured to withstand impacts resulting from a throw or other impacts and other extreme conditions such as high temperature conditions associated with a burning building, an electrical current, or an explosive device (as examples).

Observation device (throwable imaging device) 1700 may include additional components such as one or more motion sensors 194, one or more batteries such as battery 1704, memory such as memory 196, one or more processors such as processor 195, communications components such as wired or wireless communications components 1706, solar power components such as solar cell components 1708 (e.g., solar power pads), balancing structures such as weighting structures 1710, location monitoring components such as positioning components 1712 (e.g., a compass and/or global positioning system components), proximity sensors 1714, and/or one or more additional sensors such as sensors 1720.

Solar cell components 1708 may include one or more photovoltaic cells 1709 mounted on housing 1702. Photovoltaic cells 1709 may be coupled to a charge storage device such as battery 1704 so that, when light is incident on the photovoltaic cells, battery 1704 is charged. Solar cell components 1708 may form a portion of an imaging module 1701 or may be formed separately from imaging module 1701 on housing 1702.

Battery 1704 may be a lithium ion battery, a lithium polymer battery, a nickel cadmium battery, a nickel metal hydride battery, or other suitable type of battery technology for a portable throwable imaging device. System 1700 may include one, two, three, or more than three batteries. System 1700 may include one or more rechargeable batteries (e.g., batteries that are coupled to solar cell components 1708 or otherwise rechargeable batteries) and/or one or more non-rechargeable or replaceable batteries.

Weighting structures 1710 may include a portion of housing 1702 that is filled with material such as ballast material, thickened or thinned housing portions, one or more internal or external protrusions on housing 1702, fixed weighting structures that are attached to housing 1702, and/or movable weighting structures within or outside housing 1702. Weighting structures 1710 may be used to influence the orientation of device 1700 when it comes to rest after being thrown or otherwise inserted into a hostile environment. For example, weighting structure 1710 may be molded or machined portions of housing 1702 that cause device 1700 to come to rest in one of several preferred orientations that maximizes the number of imaging modules that have a clear view of the surrounding environment. In another example, the weighting structures may be internal to housing 1702. In yet another example, the weighting structures may be actuatable structures that can be moved in order to adjust the resting position of device 1700 (e.g., to roll device 1700 in one or more directions to improve the viewing angle of one or more imaging modules 1701).

Positioning components 1712 may include a compass and/or global positioning system (GPS) circuitry that can receive and transmit information regarding the geographical location of device 1700. Positioning components 1712 may be used to provide status information such as location information to an operator of device 1700 and/or to add one or more geo-location (geo-referencing) tags to images generated using imaging modules 1701.

In some embodiments, positioning components 1712 may be used in combination with motion sensors 194 and imaging modules 1701 to generate geo-referenced image data that includes geographical coordinates of objects or locations in an imaged scene.

Proximity sensors 1714 may, in one embodiment, each include a light-emitting component and a light-sensitive component. For example, a proximity sensor may have a component that emits infrared light of a selected wavelength range and a sensor that detects reflected portions of the emitted infrared light when an object is present in front of the proximity sensor. However, this is merely illustrative. In other embodiments, proximity sensors 1714 may be capacitive proximity sensors, inductive proximity sensors, acoustic proximity sensors, or other suitable sensors for detecting the proximity of an object to the sensor. Proximity sensors 1714 may be used to determine whether one or more imaging modules are blocked (e.g., facing the ground, a wall, or other obstacles). Processor 195 may be used to power down blocked imaging modules of this type to conserve power.

In another example, proximity sensors 1714 may be used to detect motion in the environment surrounding device 1700 (e.g., to detect the presence of humans moving near device 1700). In this example, processor 195 may be arranged to power down all imaging modules 1700 when no surrounding objects are detected by proximity sensors 1714 and to power on some or all of imaging modules 1701 when motion is detected. In this way, power may be conserved in situations in which it is desired to image and monitor the presence and activity of humans using device 1700 during times when no humans are present. However, this is merely illustrative. If desired, imaging modules 1701 themselves (e.g., infrared imaging modules 100) may be used to detect the presence of humans in the vicinity of device 1700 even when no motion is detected using proximity sensors 1714.

If desired, each imaging module may have one or more associated proximity sensors 1714 (e.g., mounted in a common package with the imaging module or mounted adjacent to the imaging module). However, this is merely illustrative. If desired, device 1700 may include one proximity sensor, two proximity sensors, three proximity sensors, more than three proximity sensors, or may be provided without any proximity sensors.

Memory 196 may include one or more memory devices to store data and information, including thermal images and monitoring information. The one or more memory devices may include various types of memory for thermal image and other information storage including volatile and non-volatile memory devices, such as RAM (Random Access Memory), ROM (Read-Only Memory), EEPROM (Electrically-Erasable Read-Only Memory), flash memory, and/or a disk drive. In one embodiment, thermal images and other monitoring information such as device status information or detected object information stored in the one or more memory devices may be retrieved later for purposes of reviewing and/or further diagnosing the conditions of the environment monitored by device 1700. In various embodiments, processor 195 may be configured to execute software instructions stored on memory 196 to perform various methods, processes, or operations in the manner described herein.

In this regard, communications components 1706 may be configured to handle, manage, or otherwise facilitate wired and/or wireless communication between various components of observation device 1700 and between observation device 1700 and an external device. For example, throwable imaging device 1700 may transmit and receive data to and from an external device such as a handheld device, which may receive and further process raw/processed thermal images and/or monitoring information for presentation to a user, through communications components 1706 configured to manage wired and/or wireless connections.

In various embodiments, communications components 1706 may include a wireless communication component (e.g., based on the IEEE 802.11 WiFi standards, the Bluetooth™ standard, the ZigBee™ standard, or other appropriate short range wireless communication standards), a wireless broadband component (e.g., based on WiMax technologies), mobile cellular component, a wireless satellite component, or other appropriate wireless communication components. Communications components 1706 may also be configured for a proprietary wireless communication protocol and interface based on radio frequency (RF), microwave frequency (MWF), infrared frequency (IRF), and/or other appropriate wireless transmission technologies. Communications components 1706 may include an antenna coupled thereto for wireless communication purposes. Thus, in one example, communications components 1706 may handle, manage, or otherwise facilitate wireless communication by establishing wireless link to a handheld device, to a base station, to a wireless router, hub, or other appropriate wireless networking devices.

In various embodiments, communications components 1706 may be configured to interface with a wired network via a wired communication component such as an Ethernet interface, a power-line modem, a Digital Subscriber Line (DSL) modem, a Public Switched Telephone Network (PSTN) modem, a cable modem, and/or other appropriate components for wired communication. Proprietary wired communication protocols and interfaces may also be supported by communications components 1706. Communications components 1706 may be configured to communicate over a wired link (e.g., through a network router, switch, hub, or other network devices) for wired communication purposes. For example, a wired link may be implemented with a power-line cable, a coaxial cable, a fiber-optic cable, or other appropriate cables or wires that support corresponding wired network technologies.

In some embodiments, throwable imaging device 1700 may comprise as many such communication components 1706 as desired for various applications of throwable imaging device 1700 to suit various types of monitoring environments. In other embodiments, communication components 1706 may be integrated into or implemented as part of various other components of throwable imaging device 1700. For example, infrared imaging module 100 and processor 195 may each comprise a subcomponent that may be configured to perform the operations of communications components 1706, and may communicate via wired and/or wireless connection without separate components 1706.

Motion sensors 194 may be monitored by and provide information to infrared imaging modules 100 and/or processor 195 for performing various NUC techniques described herein. Motion sensors 194 may include one or more accelerometers, gyroscopes, or other motion sensors. Motion sensors 194 may provide status information regarding the motion and orientation of device 1700 before, during, and/or after device 1700 has been deployed (e.g., thrown) in an environment.

For example, motion sensors 194 may be configured to determine the occurrence of events such as when device 1700 has been thrown, when device 1700 impacts a surface, and/or when device 1700 comes to rest after deployment. Processor 195 may be configured to operate device 1700 based on these types of detected events. For example, processor 195 may power on some or all imaging modules 1701 when it is determined using motion sensors 194 that device 1700 has come to rest after being thrown. In other examples, processor 195 may power on some or all imaging modules 1701 upon detection of a throw or impact, or imaging modules 1701 may be powered on and/or off independent of information from motion sensors 194.

Motion sensors 194 may provide status information associated with the orientation of device 1700 during imaging operations with imaging modules 1701. For example, motion sensors 194 may provide status information that indicates which portion of device 1700 is facing up or down. Status information from motion sensors 194 (and, if desired, status information form positioning components 1712) may be used to combine images captured using multiple imaging modules 1701 into a geo-referenced panoramic image.

In various embodiments, one or more components of throwable imaging device 1700 may be combined and/or implemented or not, as desired or depending on application requirements. For example, processor 195 may be combined with infrared imaging modules 100, memory 196, and/or communications components 1706. In another example, processor 195 may be combined with infrared imaging modules 100 with only certain operations of processor 195 performed by circuitry (e.g., processor, logic device, microprocessor, microcontroller, etc.) within infrared imaging modules 100.

As shown in FIG. 17B, in an embodiment, observation device (throwable imaging device) 1700 may include one or more additional sensors, such as sensors 1720. Sensors 1720 may include one or more chemical sensors such as one or more chemical sensors 1722, a radiation detector such as radiation detector 1740, a spectrometer such as spectrometer 1742, and/or other sensors 1744. One or more chemical sensors 1722 may include one or more gas sensors such as gas sensor 1730, a biosensor such as biosensor 1724, a chemical agent detector such as chemical agent detector 1726, and/or an explosives detector such as explosive detector 1728. Gas sensors 1730 may include a volatile organic compound (VOC) sensor such as VOC sensor 1732, a humidity sensor such as humidity sensor 1734, an oxygen sensor such as oxygen sensor 1736, and/or other gas sensors 1738, such as a carbon dioxide sensor or a carbon monoxide sensor (as examples).

One or more chemical sensors 1722 may detect and/or quantify one or more chemicals. Chemical sensors 1722 may be devices that transform chemical information into analytically useful signals, and may include a receptor and a transducer. The receptor may interact with the chemicals and may interact selectively to particular chemicals of interest depending on the type of chemical sensor. The transducer provides analytically useful signals based on the receptor's interaction with the chemicals. The transducer may send the signals to a processor, such as processor 195, of device 1700.

Various analytic chemistry techniques may be implemented by chemical sensors 1722. The receptor of chemical sensors 1722 may sense chemicals based on physical measurements, chemical interactions, and/or biochemical processes. In an embodiment, chemical sensors 1722 may sense chemicals based on physical measurements, such as by measuring absorbance, refractive index, conductivity, temperature, mass change, or other physical property. In another embodiment, chemical sensors 1722 may sense chemicals based on chemical interactions, such as by measuring interaction or reaction of the chemicals with the receptor molecules or sites in the receptor. In a further embodiment, chemical sensors 1722 may sense chemicals based on biochemical processes, for example, using enzyme interaction with the chemicals.

Chemical sensor 1722 may detect the presence of one or more chemicals or quantify the chemicals by measuring the concentration, proportion, or other characteristic of the chemicals. In an embodiment, chemical sensor 1722 monitors the air, such as by sampling the air, to detect and/or quantify the chemicals. For example, chemical sensor 1722 may collect airborne particles, which may be captured into a concentrated liquid sample. In another embodiment, chemical sensor 1722 detects the chemicals contained in solids and liquids that contact and collect on the receptor located on the surface of device 1700 in the process of being thrown and/or rolled into an area. In a further example, when liquid is present under or near device 1700, chemical sensor 1722 detects and/or quantifies chemicals by collecting the liquid and analyzing the liquid. For example, device 1700 may draw the liquid via a suction pump connected to a hole on the surface of device 1700 or to an extendable straw that may be extended from device 1700.

VOC sensor 1732 may detect VOCs based on an interaction between the VOCs and the receptor. In an embodiment, VOC sensor 1732 may be a suitable VOC sensor that detects VOCs in the surrounding air.

Humidity sensor 1734 may measure the moisture content of the surrounding air. In an embodiment, humidity sensor 1734 may be a capacitive humidity sensor, a resistive humidity sensor, thermal conductivity humidity sensors, or other suitable humidity sensor.

Oxygen sensor 1736 may measure the proportion or concentration of oxygen in the surrounding air. In an embodiment, oxygen sensor 1736 may be a suitable oxygen sensor that implements one or more oxygen measurement techniques.

Oxygen sensor 1736 and/or VOC sensor 1732 may be advantageously used in vaults, such as underground vaults, and other confined spaces. For example, sulfur hexafluoride is used in the electrical industry as a gaseous dielectric medium for high-voltage circuit breakers, switchgear, and other electrical equipment. When sulfur hexafluoride used in electrical equipment in a vault leaks, it floats into the lower level of the vault, thereby displacing oxygen. The proportion of oxygen may be low such that people who go into the vault may lose consciousness due to the lack of oxygen. This is unsafe and an appreciation for oxygen levels in underground vaults delivers a major safety benefit. Users may use device 1700 to conveniently measure the oxygen levels via oxygen sensor 1736 in underground vaults without going inside.

Other gas sensors 1738 may include a carbon dioxide sensor, a carbon monoxide sensor, or other gas sensor.

One or more of gas sensor 1730 may be implemented as a gas concentration detection unit. The gas concentration detection unit may be referred to colloquially as a “sniffer” which may include a solid-state chemical sensor, a photometric gas sensor, a gas chromatography unit, and/or a chemical analysis unit (CAU). The solid-state chemical sensor may comprise a single sensor or a sensor array that may sense, for example, the presence of a chemical element or compound. For example, the solid-state chemical sensor may comprise a sintered metal oxide semiconductor (MOS) element such as provided by Figaro Engineering, Incorporated of Glenview, Ill.

An exemplary solid-state chemical sensor may detect the presence and concentration of one or more gases through a change in electrical conductivity when a reducing gas is adsorbed on one or more sensor surfaces. The types of gases sensed by the gas concentration detection unit may include combustible gases, toxic gases, organic solvents, and/or hydrocarbons and other byproducts of an oil refining operation. Specifically, the gas concentration detection unit may detect methane, propane, hydrogen, carbon monoxide, ammonia, hydrogen sulfide, alcohol, toluene, xylene, refrigerant gases, and/or other volatile organic compounds (VOCs). Alternatively, the solid-state chemical sensor may include, for example, one or more chemically sensitive resistance elements that may change in electrical resistance values based on the presence and/or concentration of one or more gases. In both the MOS and chemical resistor examples, a library of solid-state detection profiles may be stored corresponding to each expected type of detectable gas.

The photometric gas sensor may comprise a single photometric detector or an array of detectors that may detect the presence and composition of one or more gases using photometric techniques relying on the ultra-violet (UV) or visible light absorption of various gas-phase chemical and chemical compounds to determine the presence and concentration of various gases. The photometric gas sensor may include an illumination chamber including one or more light sources and one or more photodetectors. A library of photometric detection profiles may be stored corresponding to each expected type of gas.

The gas chromatography unit may comprise a single chromatographic detector or an array of detectors that may detect the presence, composition, and/or concentration of one or more gases using chromatographic techniques where a gas sample in a fixed size combustion chamber or column (not shown) is heated through electrical or chemical means so that the contained gas sample emits light in various spectra corresponding to the chemical composition of the gas sample. By detection of the emitted light spectra, the chemical composition of the gas sample may be known. Further, because the size of the combustion chamber is known, by the intensity and duration of the emitted light spectra, the quantity or concentration of the constituent parts of the gas sample may be known. In this manner, both the composition and concentration of the gas may be determined. A library of chromatographic detection profiles may be stored corresponding to each expected type of gas.

The solid-state chemical sensor, the photometric gas sensor, and/or the gas chromatography unit may operate independently or cooperatively to provide gas concentration measurement information to the chemical analysis unit regarding the presence, composition, and/or concentration of one or more detected gases. The chemical analysis unit may produce a gas concentration output that may optionally be incorporated within the header file appended to, collocated, or associated with the captured image file data. The chemical analysis unit, for example, may be optional and some or all operations may be functionally performed by processor 195, as described in reference to FIG. 1.

Biosensor 1724 may detect and/or quantify biological matter. For example, biosensor 1724 may detect biological agents such as bacterial spores (e.g., B. anthracis, which causes anthrax), bacteria (e.g., Y. pestis, which causes plague), viruses (e.g., smallpox), and other biological toxins (e.g., ricin). In an embodiment, biosensor 1724 may be a suitable biosensor implementing one or more biological agent detecting techniques.

Chemical agent detector 1726 may detect the presence of toxic chemical agents. For example, chemical agent detector 1726 may detect nerve agents, blood agents, blister agents, or other toxic chemical agents. In an embodiment, chemical agent detector 1726 may be a suitable chemical agent detector implementing one or more chemical agent detecting techniques.

Explosives detector 1728 may detect the presence of explosive matter by detecting explosive vapors and/or explosive particulates. In an embodiment, explosives detector 1728 may be a suitable explosives detector, such as an explosive detector that utilize amplifying fluorescence polymers (AFP) to detect trace levels of explosive materials, for example, in parts per quadrillion (ppq).

Radiation detector 1740 may detect the presence of radioactive material and/or identify the radioactive nuclide. In an embodiment, radiation detector 1740 may be a suitable radiation detector, and may include a semiconductor radiation detector, such as a Cadmium Zinc Telluride (CZT) detector, or a scintillation detector, such as a sodium iodine (NaI) detector or a lanthanum bromide (LABr3) detector, to detect gamma radiation, detect x-rays, and/or identify the source. In another embodiment, radiation detector 1740 may include a neutron detector, such as a helium-3 (He-3) detector, to detect neutrons.

Spectrometer 1742 (e.g., spectrophotometer, spectrograph, spectroscope, spectrum analyzer, miniature mass spectrometer, or other spectrometer) may separate a wave of incoming light or incoming particles into its component parts to generate spectrometry data, such as spectral lines. The spectrometry data may be analyzed to identify materials. For example, a miniature mass spectrometer may be used to identify materials, such as by determining masses of particles or molecules and/or determining chemical structures of molecules (e.g., by ionizing chemical compounds to generate charged molecules or molecule fragments and measuring the abundance of ions having various mass-to-charge ratios).

In certain embodiments, device 1700 may include other suitable sensors 1744.

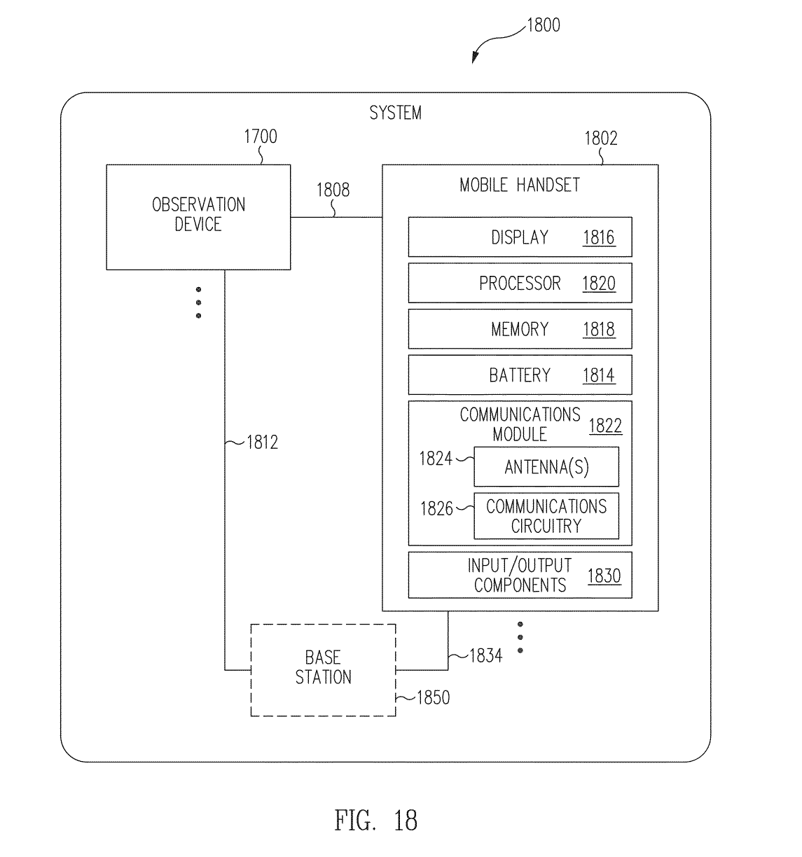

FIG. 18 is a block diagram showing how one or more durable compact multisensor observation devices such as observation device 1700 of FIG. 17A may be communicatively coupled to other components of a larger system. As shown in FIG. 18, system 1800 may include one or more observation devices 1700 and one or more mobile handsets 1802. If desired, system 1800 may also include a base station such as base station 1850. Each observation device 1700 may be a throwable imaging device that is communicatively coupled to one or more mobile handsets 1802 over communications paths such as communications path 1808 (e.g., a wireless radio-frequency communications path). In some embodiments, throwable imaging device 1700 may be communicatively coupled to mobile handset 1802 through based station 1850 (e.g., through communications path 1812 between device 1700 and base station 1850 and communications path 1834 between base station 1850 and mobile handset 1802). Communications paths 1812 and 1834 may each be a wired or wireless communications path.

As shown in FIG. 18, mobile handset 1802 may include various computing modules suitable for communicating with devices 1700 and for processing and storing images and/or other monitoring information received from devices 1700. Mobile handset 1802 may include one or more displays 1816, storage such as memory 1818, a battery 1814, processing equipment such as processor 1820, communications components such as communications module 1822, and input/output components such as input/output components 1830.

Communications module 1822 may include one or more antennas 1824 and additional communications circuitry 1826 (e.g., radio-frequency front end circuitry, signal generation circuitry, modulation circuitry, etc.). Input/output components 1830 may include a microphone, a keyboard, a touchscreen, a mouse, one or more speakers, headphones, or other components for accepting user input and providing output to a user.

Display 1816 may be configured to present, indicate, or otherwise convey images and/or other monitoring information generated by throwable imaging device 1700 (e.g., by processor 195, infrared imaging modules 100, visible light cameras 1406, motion sensors 194, proximity sensors 1714, sensors 1720 and/or positioning components 1712), and/or processor 1820. In various embodiments, display 1816 may be implemented with an electronic display screen, such as a liquid crystal display (LCD), a cathode ray tube (CRT), light-emitting-diode (LED) or various other types of generally known video displays and monitors. Display 1816 according to such embodiments may be suitable for presenting user-viewable thermal images converted by processor 195 and/or processor 1820 from thermal images captured by infrared imaging modules 100.

In some embodiments, mobile handset 1802 may be implemented as a mobile phone, a tablet device, a laptop computer, or any other suitable device for receiving, processing, and/or displaying thermal images, visible light images, combined and/or fused thermal and visible light images, and/or other monitoring information such as device status information from throwable imaging device 1700.

Base station 1850 may be implemented using desktop computers, servers, vehicle computer systems, or any other devices that may receive the thermal images and/or the monitoring information from throwable imaging device 1700.

Infrared imaging modules 100 of throwable imaging device 1700 may be configured to capture, process, and/or otherwise manage infrared images (e.g., including thermal images) of a scene such as scene 1430 (see FIG. 14). In this regard, infrared imaging modules 100 may be attached, mounted, installed, or otherwise disposed at any suitable location on or within housing 1702 of throwable imaging device 1700.

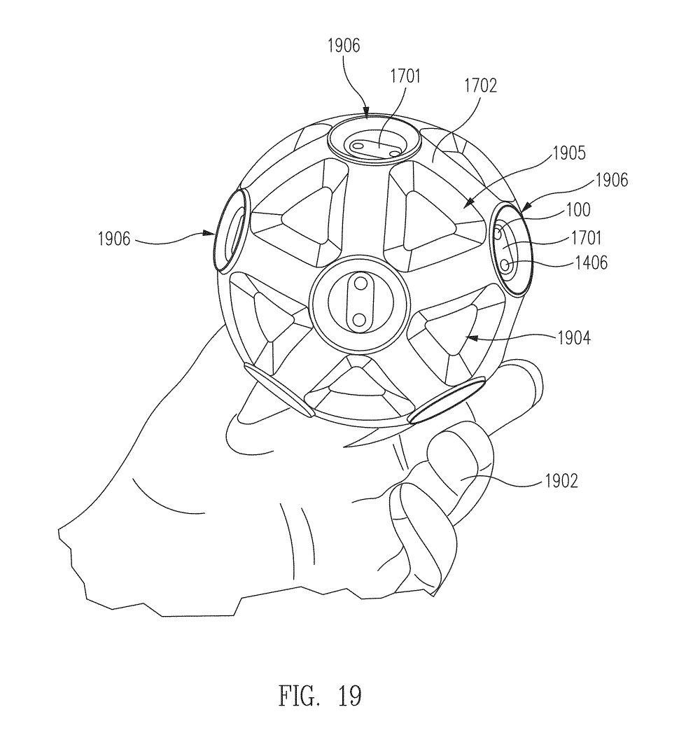

In one embodiment, several imaging modules 1701 may be disposed around some or all of a throwable structure as shown in FIG. 19. In the example of FIG. 19, durable housing 1702 of FIG. 17A is implemented as a substantially round outer housing structure having a rounded icosahedral ridge pattern with openings 1906 at the vertices of the rounded icosahedron.

The rounded icosahedral structural pattern on housing 12 may be formed from raised ridges 1905 and depressions 1904 that form the icosahedral pattern. Depressions 1904 may help reduce the weight of device 1700 while raised ridges 1905 help provide strength and durability for device 1700. Depressions 1904 and raised portions 1905 may be molded or machined features in housing 1702. Housing 1702 may be formed from metal (e.g., steel, iron, titanium, and brass), polymer materials such as polyvinyl materials, composite materials, metal alloys, or other suitable durable materials. The rounded icosahedral pattern shown in FIG. 19 is merely illustrative. If desired, housing 1702 may have other shapes such as a substantially spherical shape, a non-rounded icosahedral pattern, another rounded polyhedral pattern (e.g., a dodecahedral pattern) with openings at the vertices of the polyhedron, another non-rounded polyhedral pattern with openings at the vertices, a polyhedral pattern with openings and imaging modules at locations other than the vertices, a polyhedral pattern without depressions, a cubic shape, a shape with raised ridges and depressions formed in other patterns, or other multi-sided shapes (as examples).

Housing 1702 may have a size that is suitable for holding by a human hand such as hand 1902 of FIG. 19. As examples, housing 1702 may have a maximum exterior width of less than two inches, less than three inches, less than four inches, less than five inches, less than six inches, less than 10 inches, between three and seven inches, between two and eight inches, more than one half inch, more than three inches, more than four inches, or more than five inches.

Throwable imaging device 1700 may include any suitable number of imaging modules 1701 in any suitable number of openings 1906 in housing 1702. In one suitable example that is sometimes discussed herein as an example, device 1700 is provided with twelve imaging modules in twelve openings, each imaging module having an infrared imaging module 100 and a visible light camera 1406. However, this is merely illustrative. If desired, device 1700 may include less than twelve imaging modules, more than twelve imaging modules, more than one imaging module in a particular housing opening, more than one infrared imaging module in each imaging module, more than one visible light camera in each imaging module, only an infrared imaging module in one or more imaging modules, and/or only a visible light camera in one or more imaging modules.

Image sensors (e.g., infrared imaging modules and visible light cameras) located within a particular opening 1906 may have at least partially overlapping fields of view so that composite (combined, fused, overlapped, alternating, etc.) images from various wavelength images can be generated in each direction. Imaging modules in adjacent openings 1906 may also have at least partially overlapping fields of view so that images from multiple imaging modules can be combined to form panoramic images.

Processor 195 may be used to integrate video streams from some or all imaging modules 1701 and transmit the resulting integrated stream wirelessly to a user's mobile handset such as mobile handset 1802 of FIG. 18. Additionally, device 1700 may communicate to mobile handset 1802 the position and orientation of device 1700 after it has been thrown into a hostile or dangerous environment and has stabilized in its position.

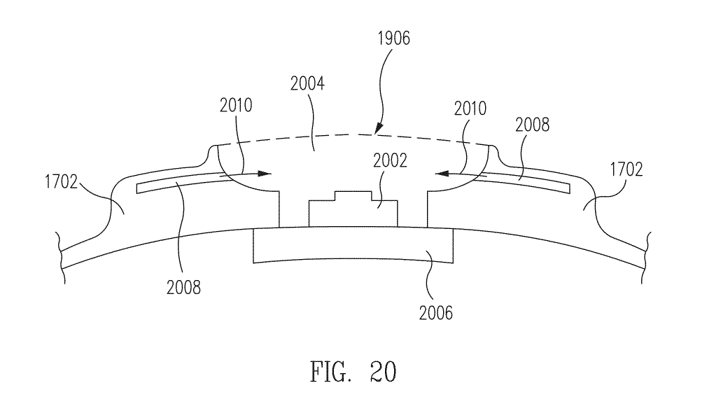

FIG. 20 is a cross-sectional view of a portion of housing 1702 that includes an opening 1906. As shown in FIG. 20, an imaging module such as imaging module 2002 may be mounted within opening 1906. Imaging module 2002 may, for example, be an infrared imaging module or a visible light camera 1406 of an imaging module 1701 in opening 1906. In some embodiments, opening 1906 may be partially or completely filled with optional material 2004 in order to seal opening 1906 from environmental intrusions (e.g., external heat, moisture, or other debris). Optional material 2004 may be a material that is transparent to light of wavelengths to be imaged by module 2002. For example, if opening 1906 contains only a visible light camera, material 2004 may be formed from glass. However, in other embodiments, openings 1906 may be provided without any filling material 2004.

In one embodiment, device 1700 may include one or more movable structures 2008 located within housing 1702 that can be moved (as indicated by arrows 2010) to temporarily close opening 1906. As examples, structures 2008 may be moved in order to close opening 1906 when temperatures outside device 1700 are above a threshold temperature or structures 2008 may be closed during deployment of device 1700 (e.g., when device 1700 is thrown) and opened when the device comes to rest (as indicated by motion sensors 194). However, this is merely illustrative. If desired, device 1700 may be provided without any structures 2008. In some embodiments, opening 1906 may be sealed by an internal structure such as structure 2006. Structure 2006 may be a structural sealing component or may be a functional component of device 1700 (e.g., a rigid or flexible printed circuit on which imaging module 2002 is mounted.

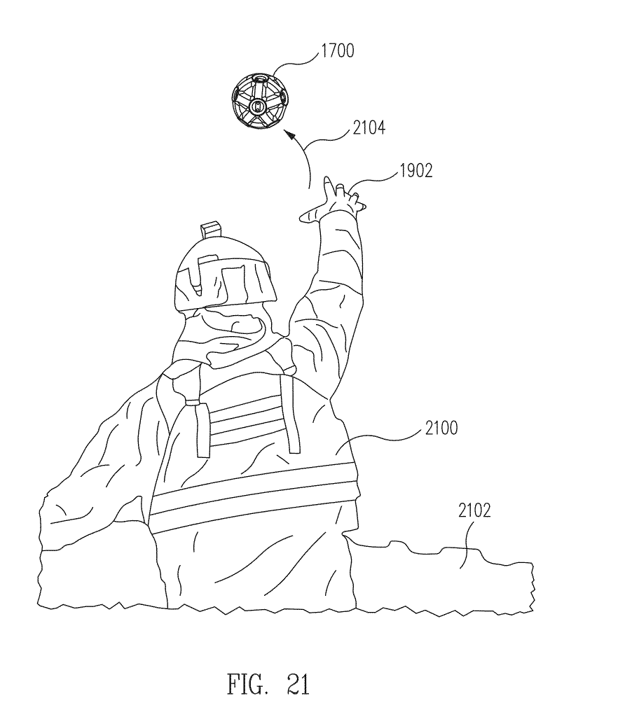

When throwable imaging device 1700 is to be inserted (deployed) into a potentially hostile environment (e.g., an environment in which a user wishes to detect and/or monitor human and/or environmental threats), a human user such as user may throw device 1700 into the environment by hand as shown in FIG. 21.

As shown in FIG. 21, user 2100 (e.g., a soldier, a law enforcement officer, a firefighter, a hazardous materials specialist, a bomb squad member, a first responder, or other human user) may use a hand such as hand 1902 to throw device 1700 as indicated by arrow 2104. Throwable imaging device 1700 may be configured to have a size, weight, and shape that facilitates throwing by a human user. For example, device 1700 may have a weight of less than 20 pounds, less than 10 pounds, less than five pounds, less than three pounds, less than one pound, between one half pound and five pounds, between one half pound and 3 pounds, between one half pound and one pound, between one ounce and one pound, between one ounce and one half pound, less than 5 ounces, or more than 1 ounce (as examples). In the example of FIG. 21, user 2100 throws device 1700 over a barrier 2102. However, this is merely illustrative. In general, a user such as user 2100 may throw device 1700 into any environment to be imaged and/or monitored (e.g., through a window into a building, through a window out of a building, from a moving vehicle, over a wall, under a bridge, etc.).

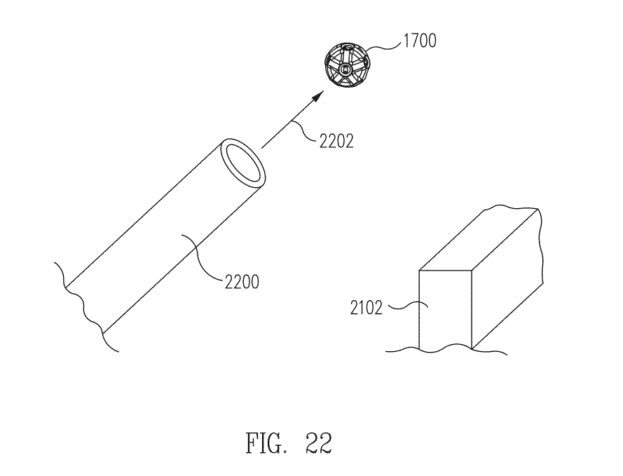

In some situations, it may be useful to project throwable imaging device 1700 further from the user than a human can throw. In this type of situation, throwable imaging device 1700 may be projected from a launching device such as launcher 2200 of FIG. 22 as indicated by arrow 2202. Launcher 2200 may be a cannon, a grenade launcher, or a flexible metal or plastic handheld launcher (as examples).

In various embodiments, throwable imaging device 1700 may be a thermal sensor grenade having a size, shape, and weight that allow device 1700 to be deployed from existing grenade launching devices for explosive grenades.

In one embodiment, throwable imaging device 1700 (e.g., processor 195) may be configured to generate image data such as thermal images from multiple imaging modules 1701 and to detect from the thermal images a contiguous region of pixels (also referred to as a “blob” or “warm blob”) having a temperature approximately in the range of a person, for example, between approximately 75° F. (e.g., clothed part of a body) and approximately 110° F. (e.g., exposed part of a body such as a face and hands). Such a “warm blob” may indicate a presence of a person in the vicinity of device 1700, and may be analyzed further as described herein to ascertain the presence of the person, track the motion of the person, determine the location of the person, and/or determine various other attributes associated with the detected person.

Processor 195 may be configured to receive thermal image data captured by infrared imaging modules 100. Processor 195 may be configured to perform, on the received thermal images of a scene, various thermal image processing and analysis operations as further described herein, for example, to detect and track one or more people, determine various attributes associated with people and/or to detect environmental threats such as fire or toxic material. Processor 195 may be configured to collect, compile, analyze, or otherwise process the outcome of the thermal image processing and analysis operations to generate monitoring information such as a geo-referenced video stream.

Throwable imaging device 1700 may be configured to detect and track the location of a person and, if desired, detect and track features of the person in the thermal images according to one or more embodiments of the disclosure. If visible light images captured by visible light cameras 1406 in imaging modules 1701 are available, throwable imaging device 1700 may be configured to track features of a scene such as multiple individual people or even the face and facial features of an individual person based additionally or alternatively on the visible light images. For example, the visible light images may provide more detail and contrast than the thermal images in certain ambient light conditions, and thus may be analyzed using suitable face tracking algorithms in such favorable light conditions. In another example, both the visible light images and the thermal images may be analyzed to complementarily increase detection and tracking accuracy. In another example, the thermal images and the visible light images may be combined or fused as further described herein, and the combined or fused images may be analyzed to track the features of the scene. If throwable imaging device 1700 is configured to detect and track the features of a scene using the visible light images, processor 195 may be further configured to convert pixel coordinates of the tracked features in the visible light images to corresponding pixel coordinates in the thermal images.

In one embodiment, system 1800 may use throwable imaging device 1700 to detect a presence of specific chemicals or gasses such as exhaled breaths of a person or animal. Exhaled breaths may appear in the thermal images for a short period after each exhalation, and may be detectable as a distinct plume of gas rich in CO₂ and having a temperature slightly lower than the body temperature. Thus, by analyzing images to detect a group of pixels having radiometric properties characteristic of such gases, exhaled breaths may be detected. Moreover, as discussed above in connection with optical elements 1403 of infrared imaging module 100, narrow-band filters may be utilized in some embodiments of modules 100 in throwable imaging device 1700, so that infrared radiation absorbed and emitted by CO₂ may be shown more clearly and in higher contrast to infrared radiation from other substances for an improved detection of exhaled breaths.

In another embodiment, system 1800 may use throwable imaging device 1700 to detect breathing by analyzing infrared images captured using one or more infrared imaging modules 100 to detect periodic variations in the temperature and/or shape of a detected oronasal region of a detected person or animal. For example, throwable imaging device 1700 may be used to detect periodic alteration of slightly higher and lower temperatures in the nostrils and/or periodic movement of the oronasal region, which may be indicative of periodic inhalation and exhalation cycles. It is also contemplated that throwable imaging device 1700 may be configured to detect breathing by performing other suitable analysis and/or processing operations, for example, for detecting various periodic variations indicative of breathing. In various embodiments, processor 195 and/or processor 1820 may be configured to detect breathing by performing any combination of breathing detection operations described herein.

In another example, monitoring information that may be generated by system 1800 using throwable imaging device 1700 includes an approximate body temperature of a typical human or animal. As described above, system 1800 may use images from throwable imaging device 1700 to locate and track a person or animal in the thermal images by analyzing the thermal images, visible light images, and/or combined thermal-visible light images from imaging modules 1701. In one embodiment, processor 195 and/or processor 1820 may be configured to determine an approximate body temperature by aggregating, averaging, and/or otherwise analyzing the radiometric data (e.g., temperature data) associated with thermal image pixels that correspond to the person or animal.

In yet another example of generating monitoring information, system 1800 may analyze thermal images from throwable imaging device 1700 to determine the approximate posture of a detected person (e.g., whether the person is standing, crouching, prone, sitting, walking, running, etc.) or the approximate orientation of the detected person (e.g., facing toward or facing away from an infrared imaging module 100). As described above, the location of body, face, and facial features of a detected person may be tracked in the thermal images. In one embodiment, system 1800 may be configured to determine the approximate posture by analyzing the location and/or orientation of the face relative to the body.

In another embodiment, the profile and/or the aspect ratio of the person in the thermal images may be analyzed to determine the posture. In various embodiments, system 1800 may be configured to determine the posture of the person by performing any combination of posture detection operations described herein and other appropriate thermal image analysis operations for posture detection.

System 1800 (e.g., processor 195 and/or processor 1820) may be configured to convert thermal images using appropriate methods and algorithms. In one embodiment, the radiometric data (e.g., temperature data) contained in the pixels of the thermal images may be converted into gray-scaled or color-scaled pixels to construct an image that can be viewed by a person. User-viewable thermal images may optionally include a legend or scale that indicates the approximate temperature of corresponding pixel color and/or intensity and a geographic legend that indicates the location of various portions of the image (e.g., based on status information from motion sensors 194 and/or positioning components 1712). Such user-viewable images may be viewed by a user (e.g., a soldier, a law-enforcement officer, a firefighter, or a first responder) on mobile handset 1802 to visually determine the location of potential threats even in dark environments (e.g., at night or in a smoke-filled environment).

If visible light images of the scene are available (e.g., captured by a visible light camera 1406), processor 195 and/or processor 1820 may superimpose, fuse, blend, alternate or otherwise combine the thermal images and the visible light images to generate user-viewable images having a higher definition and/or contrast. For example, processor 195 and/or processor 1820 may be configured to generate images that are combined images including radiometric data and/or other infrared characteristics corresponding to scene but with significantly more object detail (e.g., contour and/or edge detail) and/or contrast than typically provided by the thermal or visible light images alone, as further described herein. In another example, images may be combined images that include radiometric data and visible light characteristics (e.g., a visible spectrum color) corresponding to one or more objects (e.g., a person) in scene, as described for appropriate embodiments disclosed in various patent applications referenced herein such as, for example, U.S. Patent Application Nos. 61/473,207, 61/746,069, 61/746,074, 61/792,582, 61/793,952, 12/766,739, 13/105,765, or 13/437,645, or International Patent Application No. PCT/EP2011/056432, or others as appropriate. Combined images generated in these examples may provide sufficient radiometric data, edge detail, and contrast to allow easier recognition and/or interpretation of the presence, location, and position of human and/or environmental threats in the images.

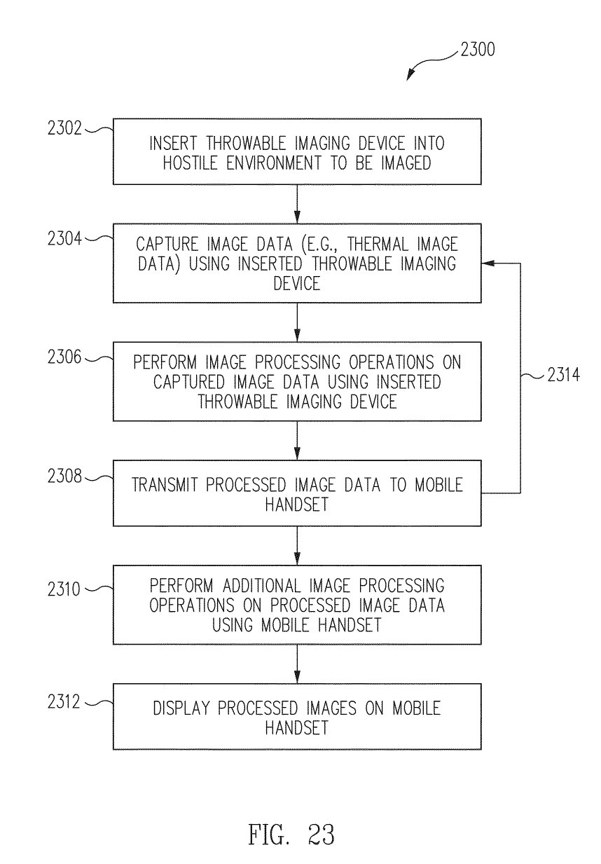

Referring now to FIG. 23, a flowchart is illustrated of a process 2300 for viewing a potentially hostile environment using a system such as system 1800 of FIG. 18 having one or more throwable imaging devices 1700.

At block 2302, a throwable imaging device such as observation device 1700 of FIGS. 17, 18, 19, 20, and 21 (as examples) may be inserted into a hostile environment to be imaged. Inserting the throwable imaging device into the hostile environment may include throwing the throwable imaging device by hand as described above in connection with FIG. 21, launching the throwable imaging device from a launcher as described above in connection with FIG. 22, or placing the throwable imaging device into the environment by hand or using a robotic placement vehicle (as examples).

At block 2304, image data (e.g., thermal images containing pixels with radiometric data) of a scene may be captured by one or more infrared imaging modules (e.g., infrared imaging modules 100 having focal plane arrays and disposed in openings around a durable housing such as housing 1702 of device 1700). The captured thermal images may be radiometrically calibrated thermal images as described above in connection with infrared imaging module 100. If desired, visible light images may also be captured in block 2304 using visible light cameras 1406 on the throwable imaging device.

Capturing the image data may include capturing short-wave infrared (SWIR) images, mid-wave infrared (MWIR) images, long-wave infrared (LWIR) images, narrow-band images, and/or visible light images (e.g., red images, blue images, green images).

In certain embodiments, one or more chemicals, biological matter, and/or radiation may be detected and/or their concentrations/proportions measured by one or more sensors (e.g., sensors 1720 of device 1700). Receptors of the one or more sensors may sense the chemicals, biological matter, and/or radiation, such as by interacting with the chemicals, biological matter, and/or radiation, and transducers of the one or more sensors may generate analytically useful signals. The analytically useful signals may provide chemical, biological, and/or radiation data, such as the detection and/or measurements of chemicals, biological matter, and/or particles.

At block 2306, processing operations may be performed on the captured image data. Processing operations may include NUC corrections, other noise corrections, calibration operations, smoothing operations, filtering operations, edge detection operations, perspective calibration operations, image compression operations, or other image processing operations. Processing operations may include stitching of image data from multiple image sensors to form wide-angle (panoramic) images. Additional processing operations may also be performed on visible light images optionally captured in accordance with block 2304. Is some embodiments, image processing operations performed in block 2306 may include combining or fusing thermal images and visible light images as described above in connection with FIGS. 14 and 16 (as examples). NUC correction processes may be performed on the captured thermal images to remove noise therein, for example, by using various NUC techniques disclosed herein.

Also, in some embodiments, the captured thermal images may be scaled and/or perspective calibrated and/or geo-referenced. Scaling and perspective calibration operations may be performed manually or automatically using scaling or perspective calibration data stored in memory 196. Geo-referencing operations may use data from additional components such as motion sensors, positioning components, and/or proximity sensors.

In certain embodiments, processing operations may be performed on the chemical, biological, and/or radiation data to generate further chemical, biological, and/or radiation data and/or chemical, biological, and/or radiation information, such as by performing risk analysis and/or toxicity analysis. At block 2308, processed image data may be transmitted to a mobile handset such as mobile handset 1802 of FIG. 18. Transmitting the processed image data may include transmitting the image data wirelessly. Transmitting the processed image data may include transmitting geo-referenced images such as geo-referenced panoramic LWIR images to the mobile handset. Transmitting the processed image data may include transmitting additional data such as motion sensor data (e.g., device motion and orientation data), positioning data (e.g., OPS coordinates and compass data), and proximity sensor data to the mobile handset. The additional data may be transmitted as embedded data in transmitted images or may be transmitted separately from the image data.

In one embodiment, the data to be transmitted may be converted, wrapped, structured, encrypted, or otherwise formatted for data exchange with the mobile handset using suitable application layer protocols (e.g., Simple Object Access Protocol (SOAP), Hypertext Transfer Protocol (HTTP)) or a proprietary data exchange format.

In certain embodiments, chemical, biological, and/or radiation data and information generated by the one or more sensors and/or the processor of the throwable imaging device may be transmitted to a mobile handset such as mobile handset 1802 of FIG. 18.

At block 2310, additional image processing operations may be performed on image data received from the throwable imaging device such as the processed image data using the mobile handset (e.g., using processor 1820). Additional image processing operations may include any or all of the processing operations described above in accordance with block 2304 and/or other processing operations such as decompression operations, color correction operations, object detection operations, hazardous material detection operations, heat detection operations or other suitable image processing and analyzing operations.

Detecting objects may include identifying image pixels in the thermal images that correspond to the temperature of a person or an animal, identifying image pixels that correspond to materials such as chemicals and/or exhaled gasses, or otherwise identifying characteristics of an image that correspond to the desired object or material to be detected.

For example, various analysis and processing operations may be performed on the captured thermal images to detect and track objects such as a person, and determine various attributes associated with the detected object and/or the scene. In one embodiment, regions of contiguous pixels having temperature values in a specific range may be detected from radiometrically calibrated thermal images for detection and of the object. For example, the detection operation may differentiate a region (or a “blob”) having a surface temperature distribution that is characteristic of a human. The thermal images and the blob detected therein may be further processed and/or analyzed, for example, by performing various filtering operations and analyzing the size, shape, and/or thermal characteristics of the blobs, to ascertain the detection of the person and to further localize the person. In some embodiments, features of a person such as face and facial features may also be detected. As described above with respect to FIG. 15, various features of a person (e.g., facial features such as the eyes, mouth, and nostrils, clothed portions, or objects the person may be holding) generally exhibit various corresponding temperatures. Thus, in one example, filtering operations such as dilation and threshold filtering performed on the detected blob may be utilized to further localize the features. Also, the size, shape, and/or radiometric properties of the localized features may be further analyzed, if needed, to ascertain the detection of the features.

In another embodiment, the thermal images may be analyzed to detect one or more candidate foreground objects, for example, using background modeling techniques, edge detection techniques, or other foreground object detection techniques suitable for use with thermal images. The radiometric properties (e.g., surface temperature distribution) of the candidate objects may then be analyzed to determine whether they correspond to those of person that may be present in the scene. For example, rocks or trees may initially be detected as a candidate foreground object, but radiometric properties of the objects may then quickly reveal that it does not have a surface temperature distribution characteristic of a person and thus is not a person. As this example shows, object detection using the thermal images may be less susceptible to false detection of spurious objects compared with object detection techniques using visible light images. The size and shape of the candidate objects may also be analyzed, so that the detection may be ascertained based on the size, the shape, and the radiometric properties of the detected candidates. As described above, further processing and analysis operations may be performed if needed to localize and track the features of the person.

In one aspect of this embodiment, background modeling techniques may be used to detect objects in the scene. Because the background of the scene rarely changes and because thermal images are generally insensitive to changing lighting conditions, a background model (e.g., pixels that belong to a background) may be constructed with high accuracy, and a region of pixels different from the background (also referred to as a “region of interest”) may easily be distinguished as a candidate foreground object. As described above, the radiometric properties of such a region of interest (ROI) may then be analyzed to further ascertain whether the detected ROI likely represent a person.

In various embodiments, the various processing and analysis operations described for block 2310 may be omitted or included, and may be performed in any other order as appropriate for detecting a person. For example, in some embodiments, detecting a warm “blob” in the thermal images may be sufficient to detect and track a person in a scene, whereas in other embodiments various thermal image analytics may be performed in combination to increase the accuracy of the detection.

In some embodiments, if visible light images are available (e.g., captured by visible light camera 1406), operations for block 2310 may additionally or alternatively involve visible light image processing such as performing suitable face detection and tracking algorithms on the visible light images or combined images of the visible light images and the thermal images. If the detection and tracking of the face and facial features are performed using the visible light images, operations for block 2310 may further involve converting pixel coordinates of the tracked face and facial features in the visible light images to corresponding pixel coordinates in the thermal images. Other appropriate techniques for detecting objects in the thermal images by analyzing the thermal images, visible light images, and/or combined images may also be utilized for block 2310.

In various embodiments, the processing operations of blocks 2304 and 2310 may be performed by the throwable imaging device before transmission to the mobile handset or by the mobile handset after transmission from the throwable imaging device. In one embodiment, all image processing operations are performed by the throwable imaging device. In another embodiment, raw image data is transmitted from the throwable imaging device to the mobile handset and all image processing operations are performed by the mobile handset. In other embodiments, the image processing operations may be shared between the throwable imaging device and the mobile handset.

In certain embodiments, additional processing operations may be performed on chemical, biological, and/or particle data and/or information received from the throwable imaging device using the mobile handset (e.g., using processor 1820).

At block 2312, processed images (e.g., user-viewable thermal images, visible lights images, or fused thermal and visible light images) may be displayed on the mobile handset. Displaying the processed images may include displaying panoramic geo-referenced thermal images (e.g., MWIR images, LWIR images, or other thermal images) on the display of the mobile handset. Displaying the processed images may include continuously displaying transmitted video images such as panoramic geo-referenced thermal images of a scene. As indicated by arrow 2314, the throwable imaging device may return to block 2304 and capture and process additional image data for generation and transmission of a continuous video image stream.

In certain embodiments, chemical, biological, and/or particle data and/or information may be displayed on the mobile handset.

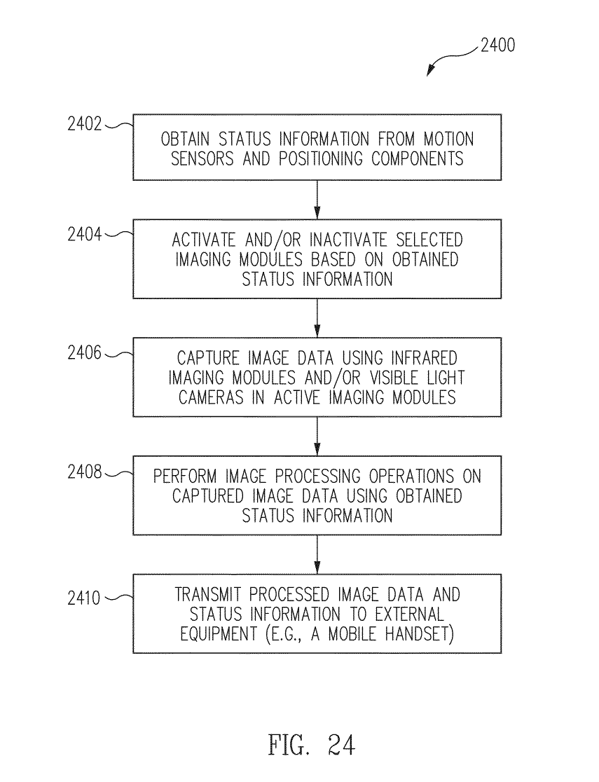

Referring now to FIG. 24, a flowchart is illustrated of a process 2400 for monitoring an environment using a throwable imaging device such as throwable imaging device 1700.

At block 2402, status information from motions sensor and positioning components may be obtained. The status information may be device orientation data, device location data, and/or device motion data obtained by a processor such as processor 195 from, for example, one or more accelerometers, one or more gyroscopes, a compass, and/or a GPS unit. The status information may include the position and orientation of the throwable imaging system. The status information may also include proximity information from a proximity sensor that indicates whether any imaging modules are blocked by objects such as the ground.

At block 2404, selected imaging modules may be activated or inactivated based on the obtained status information. In one embodiment, all imaging modules may be active and imaging modules that have been determined to be blocked (e.g., using proximity sensor information or device orientation information) may be deactivated. In another embodiment, all imaging modules may be inactive, and imaging modules that have been determined to be unblocked may be activated.

At block 2406, image data such as infrared image data and visible light image data may be captured using infrared imaging modules (e.g., at focal plane arrays of the infrared imaging modules) and/or visible light cameras in active imaging modules on the throwable imaging device.

At block 2408, image processing operations may be performed on the captured image data using the obtained status information.

At block 2410, the processed image data and obtained status information may be transmitted to external equipment such as mobile handset 1802.

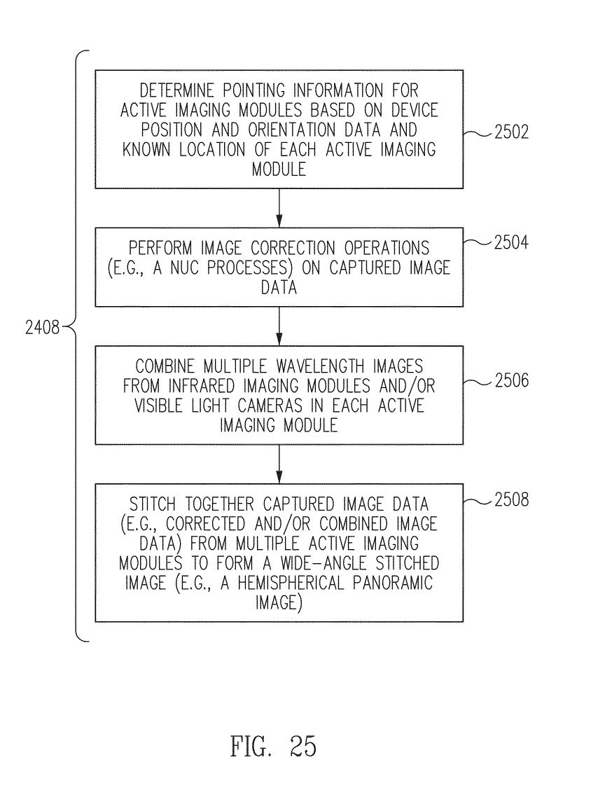

Illustrative operations that may be involved in the image processing operations of block 2408 are shown in FIG. 25.

At block 2502, pointing information for each active imaging module may be determined based on device position and orientation data (e.g., data obtained in block 2402) and on known locations of each active imaging module in the throwable imaging device. For example, the relative or absolute angular position of each sensor in each active imaging module may be determined based on the position and orientation of the device and the known location of each sensor in that imaging module.

At block 2504, image correction operations such as a NUC process, image calibration operations, color correction operations, other noise correction operations, or other image correction operations as described herein may be performed on the captured image data.

At block 2506, multiple wavelength images (e.g. NIR, SWIR, MWIR, LWIR, red, green, and/or blue images) from infrared imaging modules and/or visible light cameras in each active imaging module may be combined (e.g., overlaid, fused, or otherwise combined as described herein in connection with FIG. 16) to form wavelength composite images for each active imaging module.

At block 2508, captured image data (e.g., raw image data or corrected and/or combined image data generated in blocks 2504 and/or 2506) from multiple active imaging modules may be stitched together to form a wide-angle stitched image such as a hemispherical panoramic image (e.g., a hemispherical panoramic LWIR image). Stitching together image data from multiple active imaging modules may include determining overlapping pixels in images from neighboring imaging modules, registering the overlapping pixels from each imaging module to a common pixel grid, warping or dewarping images, and combining images on the common pixel grid using the registered pixels. If desired, stitching together the image data may include stitching together the image data using the determined pointing information determined in accordance with block 2502 to align images from individual imaging modules onto a common reference grid (e.g., a geo-referenced grid that is mapped to real world coordinates based on the determined position and orientation of the device).

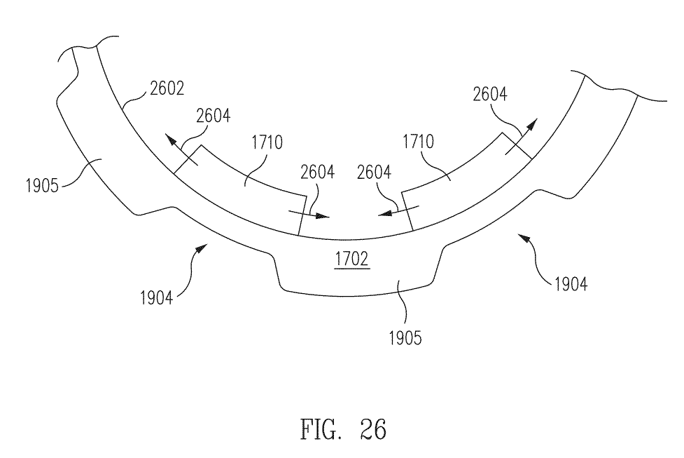

FIG. 26 is a cross-sectional view of a portion of housing 1702 that includes weighting structures 1710. As shown in FIG. 26, weighting structures 1710 may be formed on a portion of the interior surface 2602 of housing 1702. Structures 1710 may be formed from the same material as housing 1702 or may be a different material (e.g., metal, plastic, or other suitably weighted material). Structures 1710 may be formed from a thickened portion of housing 1702 or from a material that is attached to housing 1702 (e.g., using adhesives, welds, or mechanical attachment members).

Structures 1710 may be attached to housing 1702 in a fixed position or may be movable structures. Fixed structures may be formed on housing 1702 so that there is a preferred resting position for device 1700. For example, two weighting structures of the type shown in FIG. 26 on a common portion of housing 1702 may cause that portion of housing 1702 to be preferably pulled down and therefore located preferably at the bottom of device 1700 after a throw or roll.

Movable structures may be able to be moved (e.g., in directions 2604) in order to shake or roll device 1700 from a first position to a second position (e.g., from behind an obstacle that blocks a preferred viewing direction). Movable structures 1710 may be moved automatically based on image data from imaging modules 1710 and/or other device status information or movable structures 1710 may be controlled by an operator of mobile handset 1802. However, the interior weighting structures of the type shown in FIG. 26 are merely illustrative. If desired, device 1700 may be provided without any interior weighting structures. In this type of configuration, depressions 1904 and ridges 1905 may serve as weighting structures that influence the final resting position of device 1700 in addition to advantageously strengthening and reducing the weight of housing 1702.

Although various image processing techniques have been described, any of the various processing techniques set forth in any of the patent applications referenced herein may be used. For example, in some embodiments, visible images and/or thermal images may be blended or otherwise combined in accordance with any of the techniques set forth in U.S. Patent Application Nos. 61/473,207, 61/746,069, 61/746,074, 61/792,582, 61/793,952, 12/766,739, 13/105,765, or 13/437,645, or International Patent Application No. PCT/EP2011/056432, or others as appropriate.

Where applicable, various embodiments provided by the present disclosure can be implemented using hardware, software, or combinations of hardware and software. Also where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as non-transitory instructions, program code, and/or data, can be stored on one or more non-transitory machine readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the invention. Accordingly, the scope of the invention is defined only by the following claims.

What is claimed is:

1. A throwable imaging device, comprising:
a housing structure having a plurality of openings, wherein the housing structure is configured to withstand an impact resulting from being thrown; and
an imaging module in each of the plurality of openings, wherein at least one of the imaging modules is configured to capture a thermal image.

2. The throwable imaging device of claim 1, wherein the housing structure comprises a durable housing structure having a plurality of raised ridges.

3. The throwable imaging device of claim 2, wherein the plurality of raised ridges form a polyhedral pattern, and wherein each of the plurality of openings is formed at a vertex of the polyhedral pattern.

4. The throwable imaging device of claim 1, wherein each imaging module comprises a long wavelength infrared imaging module including at least one microbolometer.

5. The throwable imaging device of claim 4, further comprising:
a processor configured to stitch together long wavelength infrared images from at least some of the long wavelength infrared imaging modules to form a wide-angle long wavelength infrared image; and
one or more sensors comprising at least one of a gas sensor, an oxygen sensor, a volatile organic compound sensor, a biosensor, a chemical agent detector, an explosives sensor, and/or a radiation detector.

6. The throwable imaging device of claim 5, wherein the wide-angle long wavelength infrared image comprises a hemispherical long wavelength infrared image, and wherein the processor is further configured to correct at least one of the long wavelength thermal images according to a non-uniformity correction process using an intentionally blurred thermal image.

7. The throwable imaging device of claim 1, further comprising a wireless communications component for transmitting the captured thermal image to external equipment.

8. The throwable imaging device of claim 1, further comprising a proximity sensor and/or a solar power pad.

9. The throwable imaging device of claim 1, further comprising an internal weighting component that influences an orientation of the throwable imaging device.

10. The throwable imaging device of claim 1, further comprising a positioning component for generating position data for the throwable imaging device.

11. The throwable imaging device of claim 10, further comprising a processor configured to combine the position data and image data captured using the imaging modules to generate a geo-referenced image.

12. A method, comprising:
inserting a durable compact multisensor observation device into an environment;
capturing, at a focal plane array of an infrared imaging module that is mounted on the durable compact multisensor observation device, a thermal image of a portion of the environment; and
transmitting the captured thermal image to a mobile handset.

13. The method of claim 12, wherein the inserting the durable compact multisensor observation device into the environment comprises throwing, by a human user, of the durable compact multisensor observation device into the environment.

14. The method of claim 12, wherein the inserting the durable compact multisensor observation device into the environment comprises launching, by a launching device, of the durable compact multisensor observation device into the environment.

15. The method of claim 12, further comprising:
capturing, at additional focal plane arrays of additional infrared imaging modules that are mounted on the durable compact multisensor observation device, additional thermal images of additional portions of the environment; and
combining the captured thermal image and the additional captured thermal images to form a wide-angle thermal image.

16. The method of claim 15, wherein the transmitting the captured thermal image to the mobile handset comprises transmitting the wide-angle thermal image to the mobile handset, the method further comprising displaying the wide-angle thermal image using the mobile handset.

17. A system comprising:
an observation device configured to be thrown into a potentially hostile environment and to capture a thermal image of at least a portion of the potentially hostile environment; and
a mobile handset configured to wirelessly receive the captured thermal image from the observation device.

18. The system of claim 17, wherein the observation device comprises:
a durable housing structure having openings;
an imaging module in each of the openings;
a processor configured to process the captured thermal image; and
communications components for transmitting the captured thermal image to the mobile handset.

19. The system of claim 18, wherein the mobile handset comprises:
a processor for further processing the received captured thermal image; and
a display for displaying the processed thermal image.

20. The system of claim 19, wherein at least one of the imaging modules comprises:
an infrared imaging module; and
a non-thermal imaging module, wherein the processor is configured to generate an image comprising high-spatial frequency content from an image generated using the non-thermal imaging module fused with the captured thermal image.
